(19) United States
(12) Patent Application Publication
(10) Pub. No.: US 2024/0408885 A1
(43) Pub. Date: Dec. 12, 2024

(54) CIRCULATION UNIT, LIQUID EJECTION HEAD, AND LIQUID EJECTION APPARATUS

(71) Applicant: CANON KABUSHIKI KAISHA, Tokyo (JP)

(72) Inventors: KOICHI KUBO, Kanagawa (JP); MANABU OHARA, Tokyo (JP); KAZUYA YOSHII, Kanagawa (JP)

(21) Appl. No.: 18/679,179

(22) Filed: May 30, 2024

(30) Foreign Application Priority Data
Jun. 7, 2023 (JP) 2023-094246

(51) Int. Cl. B41J 2/18; B41J 2/175

(52) U.S. Cl. CPC B41J 2/18; B41J 2/17596

(57) ABSTRACT

A relation of VV<V2 is satisfied, where VV is a volume of fluid passing a communication port of a first pressure control chamber of a first pressure adjustment unit and a fourth passage communicating with a circulating pump and the first pressure control chamber, in a direction from the first pressure control chamber toward the fourth passage in a period from a time when operation of the circulating pump is stopped to a time when pressure in the first pressure control chamber and pressure in the second pressure control chamber become equal to each other, and V2 is a volume of the fourth passage.

### BACKGROUND OF THE DISCLOSURE

### Field of the Disclosure

The present disclosure relates to a circulation unit, a liquid ejection head, and a liquid ejection apparatus.

### Description of the Related Art

There is known a circulation type liquid ejection apparatus that discharges air bubbles in passages and suppresses thickening of ink near ejection ports by circulating liquid between a liquid ejection head and a liquid storage portion. The circulation type liquid ejection apparatus includes a liquid ejection apparatus that circulates liquid between a liquid ejection head and a main body by using a main body side pump outside the liquid ejection head and a liquid ejection apparatus that circulates liquid in a liquid ejection head by using a pump inside the liquid ejection head. Japanese Patent Laid-Open No. 2019-59046 (hereinafter, referred to as literature) discloses a liquid ejection apparatus that circulates ink in a head by using a circulating pump mounted on the main body side. In the configuration of the literature, the ink supplied from the circulating pump to a first tank is supplied to the liquid ejection head via a primary-side circulation path, and the not-ejected ink is collected into the circulating pump via a secondary-side circulation path and a second tank.

In the literature, ink amounts in the upstream tank and the downstream tank are read by two float-type liquid level sensors, and the ink is replenished by a replenishment pump based on levels of ink liquid surfaces detected by the two sensors. However, in the two float-type liquid level sensors, float portions sometimes malfunction due to bubbling of the ink depending on the configuration. Accordingly, there is a possibility that the ink liquid surface in at least the downstream tank becomes low. In a case where the ink liquid surface becomes low, there is a possibility that an outlet or an inlet of a passage communicating with the circulating pump is exposed to air and air enters the circulating pump. If air flows into a pump chamber of a small piezoelectric pump serving as the circulating pump as in the literature, depending on the configuration, there is a possibility that the circulating pump cannot generate desired pressure due to the flowing-in air acting as a damper, and this causes a decrease in a flow rate and a decrease in ejection stability.

### SUMMARY OF THE INVENTION

One embodiment of the present disclosure is a circulation unit comprising: a first pressure adjustment unit configured to adjust pressure of liquid, the first pressure adjustment unit including a first valve chamber, a first pressure control chamber, a first communication port that allows the first valve chamber and the first pressure control chamber to communicate with each other, a first valve that opens and closes the first communication port, a first flexible member that forms a surface of a portion of the first pressure control chamber and that is configured to be displaceable, and a first pressure plate that forms a surface of another portion of the first pressure control chamber and that is configured to be displaceable by moving together with the first flexible member; a second pressure adjustment unit configured to adjust pressure of liquid, the second pressure adjustment unit including a second valve chamber, a second pressure control chamber, a second communication port that allows the second valve chamber and the second pressure control chamber to communicate with each other, a second valve that opens and closes the second communication port, a second flexible member that forms a surface of a portion of the second pressure control chamber and that is configured to be displaceable, and a second pressure plate that forms a surface of another portion of the second pressure control chamber and that is configured to be displaceable by moving together with the second flexible member; a first passage configured to allow a pressure chamber and the first pressure control chamber to communicate with each other; a second passage configured to allow the pressure chamber and the second pressure control chamber to communicate with each other; a third passage configured to allow the second pressure control chamber and a circulating pump to communicate with each other, the circulating pump used to circulate liquid; and a fourth passage configured to allow the circulating pump and the first pressure control chamber to communicate with each other, and VV<V2 is satisfied, where VV is a volume of fluid passing a communication port of the first pressure control chamber and the fourth passage in a direction from the first pressure control chamber toward the fourth passage in a period from a time when operation of the circulating pump is stopped to a time when pressure in the first pressure control chamber and pressure in the second pressure control chamber become equal to each other, and V2 is a volume of the fourth passage.

Further features of the present disclosure will become apparent from the following description of exemplary embodiments with reference to the attached drawings.

### BRIEF DESCRIPTION OF THE DRAWINGS

FIGS. 1A and 1B are a perspective diagram and a function block diagram of a liquid ejection apparatus;

FIG. 2 is an exploded perspective diagram of a liquid ejection head;

FIGS. 3A and 3B are a vertical cross-sectional diagram of the liquid ejection head and an enlarged cross-sectional diagram of an ejection module;

FIG. 4 is a perspective diagram illustrating an outline of an outer appearance of a circulation unit;

FIG. 5 is a vertical cross-sectional diagram illustrating a circulation path;

FIG. 6 is a block diagram schematically illustrating the circulation path;

FIGS. 7A to 7C are cross-sectional diagrams illustrating an example of a pressure adjustment unit;

FIGS. 8A and 8B are outer appearance perspective diagrams of a circulating pump;

FIG. 9 is a cross-sectional diagram of the circulating pump illustrated in FIG. 8A along the IX-IX line;

FIGS. 10A to 10E are diagrams for explaining flows of ink in the liquid ejection head;

FIGS. 11A and 11B are schematic diagrams illustrating the circulation path in the ejection unit;

FIG. 12 is a diagram illustrating an opening plate;

FIG. 13 is a diagram illustrating an ejection element substrate;

FIGS. 14A to 14C are cross-sectional diagrams illustrating ink flows in the ejection unit;

FIGS. 15A and 15B are cross-sectional diagrams illustrating an area around an ejection port;

FIGS. 16A and 16B are cross-sectional diagrams illustrating a comparative example of the area around the ejection port;

FIG. 17 is a diagram illustrating a comparative example of the ejection element substrate;

FIGS. 18A and 18B are diagrams illustrating a passage configuration of the liquid ejection head;

FIG. 19 is a diagram illustrating passages after stop of ink circulation in the liquid ejection apparatus;

FIGS. 20A to 20C illustrate a change of state in a second pressure adjustment unit; and

FIG. 21 illustrates a relationship between the pressure and volume of the second pressure adjustment unit.

### DESCRIPTION OF THE EMBODIMENTS

A preferable embodiment of the present disclosure is explained below in detail with reference to the attached drawings. Note that the following embodiment does not limit the matters of the present disclosure, and not all of combinations of features explained in the present embodiment are necessarily essential for the solving means of the present disclosure. Note that the same constituent elements are denoted by the same reference numerals. The present embodiment is explained by using an example in which ejection elements for ejecting liquid adopt a thermal method in which the liquid is ejected by generating air bubbles with electrothermal converting elements. However, the present disclosure is not limited to this. The present disclosure can be applied also to a liquid ejection head adopting an ejection method in which the liquid is ejected by using piezoelectric elements or other ejection methods. Moreover, pumps, pressure adjustment units, and the like explained below are not limited to the configurations described in the embodiment and the drawings. In the following explanation, a basic configuration of the present disclosure is described first, and then characteristic portions of the present disclosure are explained.

### <Liquid Ejection Apparatus>

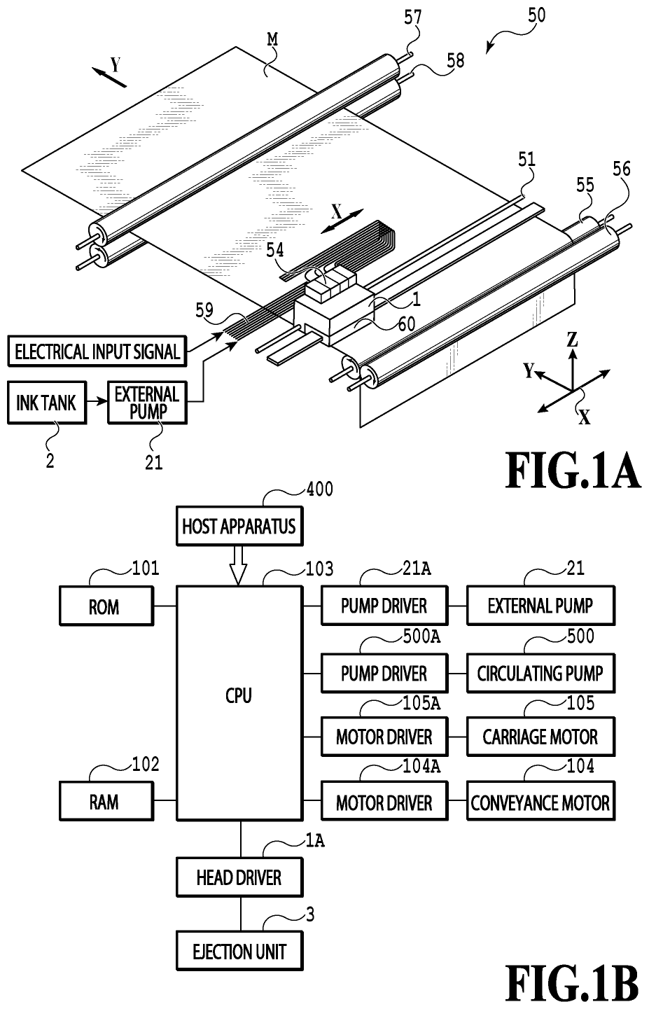

FIGS. 1A and 1B are diagrams for explaining a liquid ejection apparatus, and include an enlarged diagram of a liquid ejection head of the liquid ejection apparatus and its periphery. First, a schematic configuration of a liquid ejection apparatus 50 in the present embodiment is explained with reference to FIGS. 1A and 1B. FIG. 1A is a perspective diagram schematically illustrating the liquid ejection apparatus using a liquid ejection head 1. The liquid ejection apparatus 50 of the present embodiment forms a serial inkjet printing apparatus that performs printing on a print medium P by ejecting inks as the liquid while performing scanning of the liquid ejection head 1.

The liquid ejection head 1 is mounted in a carriage 60. The carriage 60 reciprocally moves in a main scanning direction (X direction) along a guide shaft 51. The print medium P is conveyed in a sub scanning direction (Y direction) intersecting (orthogonal to in the present example) the main scanning direction by conveyance rollers 55, 56, 57, and 58. Note that, in each of the drawings referred to below, a Z direction is a vertical direction, and intersects (is orthogonal to in the present example) an X-Y plane defined by the X direction and the Y direction. The liquid ejection head 1 is configured to be capable of being attached to and detached from the carriage 60 by a user.

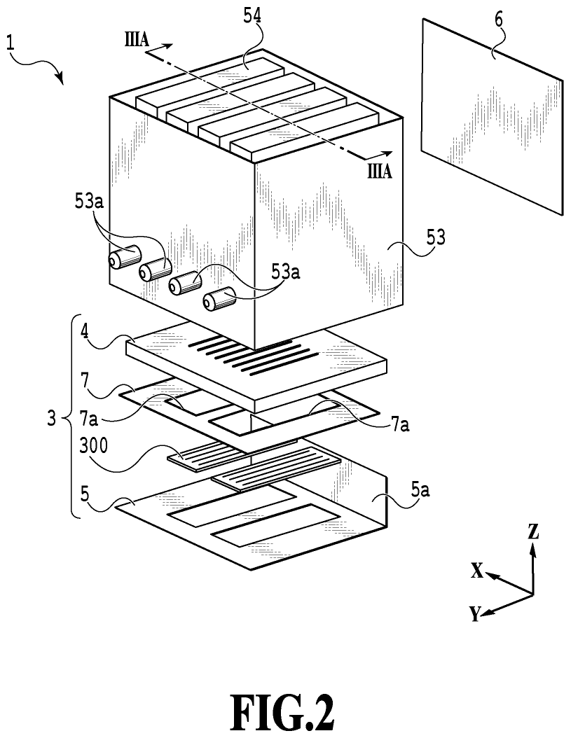

The liquid ejection head 1 is configured to include circulation units 54 and an ejection unit 3 (see FIG. 2) to be described later. Although specific configurations are described later, multiple ejection ports and energy generating elements (hereinafter, referred to as ejection elements) that generate ejection energy for ejecting the liquid from the ejection ports are provided in the ejection unit 3.

Moreover, ink tanks 2 that are supply sources of the inks and external pumps 21 are provided in the liquid ejection apparatus 50. The inks stored in the ink tanks 2 are supplied to the circulation units 54 via ink supply tubes 59 by drive force of the external pumps 21.

The liquid ejection apparatus 50 forms a predetermined image on the print medium P by repeating print scanning in which the inks are ejected while the liquid ejection head 1 mounted on the carriage 60 is moved in the main scanning direction to perform printing and a conveyance operation in which the print medium P is conveyed in the sub scanning direction. Note that the liquid ejection head 1 in the present embodiment can eject four types of inks of black (K), cyan (C), magenta (M), and yellow (Y), and a full-color image can be printed by using these inks. However, the inks that can be ejected from the liquid ejection head 1 are not limited to the above-mentioned four types of inks. The present disclosure can be also applied to a liquid ejection head for ejecting other types of inks. In other words, the types and number of inks ejected from the liquid ejection head are not limited.

Moreover, the liquid ejection apparatus 50 is provided with a cap member (not illustrated) that can cover an ejection port surface on which the ejection ports of the liquid ejection head are formed, at a position offset from a conveyance path of the print medium P in the X direction. The cap member covers the ejection port surface of the liquid ejection head 1 in a non-print operation, and is used for prevention of drying of the ejection ports, protection thereof, an operation of sucking the inks from the ejection ports, and the like.

Note that, although the liquid ejection head 1 illustrated in FIG. 1A illustrates an example in which the liquid ejection head 1 includes four circulation units 54 corresponding to the four types of inks, the liquid ejection head 1 only needs to include circulation units 54 corresponding to the types of liquids to be ejected. Moreover, the liquid ejection head 1 may include multiple circulation units 54 for the same type of liquid. In other words, the liquid ejection head 1 can be configured to include one or more circulation units. The liquid ejection head 1 may be configured such that not all of the four types of inks are circulated and at least one ink is circulated.

FIG. 1B is a block diagram illustrating a control system of the liquid ejection apparatus 50. A CPU 103 performs a function as a control unit configured to control operations of the units of the liquid ejection apparatus 50 based on a program such as a processing procedure stored in the ROM 101. A RAM 102 is used as a working area or the like in a case where the CPU 103 executes processes. The CPU 103 receives image data from a host apparatus 400 outside the liquid ejection apparatus 50 to control a head driver 1A, and controls drive of the ejection elements provided in the ejection unit 3. Moreover, the CPU 103 controls drivers of various actuators provided in the liquid ejection apparatus. For example, the CPU 103 controls a motor driver 105A of a carriage motor 105 used to move the carriage 60, a motor driver 104A of a conveyance motor 104 used to convey the print medium P, and the like. Furthermore, the CPU 103 controls a pump driver 500A configured to drive circulating pumps 500 to be described later, a pump driver 21A of the external pumps 21, and the like. Note that, although a mode in which the CPU 103 performs a process of receiving image data from the host apparatus 400 is illustrated in FIG. 1B, the process may be performed in the liquid ejection apparatus 50 irrespective of data from the host apparatus 400.

### <Basic Configuration of Liquid Ejection Head>

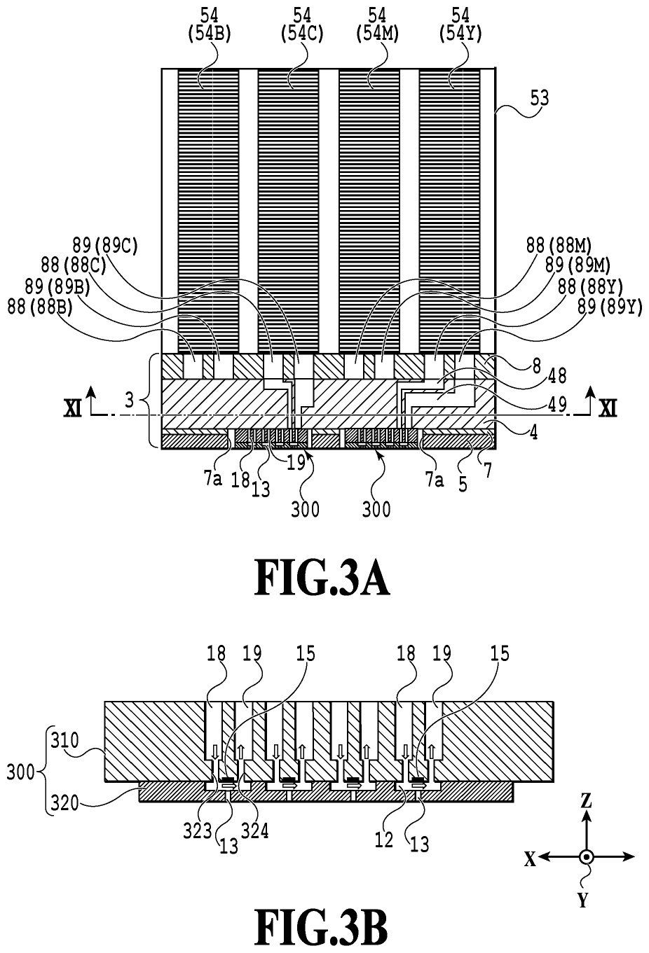

FIG. 2 is an exploded perspective diagram of the liquid ejection head 1 of the present embodiment. FIGS. 3A and 3B are cross-sectional diagrams of the liquid ejection head 1 illustrated in FIG. 2 along the IIIA-IIIA line. FIG. 3A is a vertical overall cross-sectional diagram of the liquid ejection head 1, and FIG. 3B is an enlarged diagram of an ejection module illustrated in FIG. 3A. A basic configuration of the liquid ejection head 1 in the present embodiment is explained below with reference mainly to FIG. 2 and FIGS. 3A and 3B, and, if necessary, to FIGS. 1A and 1B.

As illustrated in FIG. 2, the liquid ejection head 1 is configured to include the circulation units 54 and the ejection unit 3 for ejecting the inks supplied from the circulation units 54 to the print medium P. The liquid ejection head 1 in the present embodiment is fixed to and supported on the carriage 60 by using not-illustrated positioning unit and electric contacts provided in the carriage 60 of the liquid ejection apparatus 50. The liquid ejection head 1 ejects the inks while moving in the main scanning direction (X direction) illustrated in FIGS. 1A and 1B together with the carriage 60 to perform printing on the print medium P.

Each of the external pumps 21 connected to the ink tanks 2 being the supply sources of the inks is provided with the ink supply tube 59 (see FIGS. 1A and 1B). A not-illustrated liquid connector is provided at a front end of the ink supply tube 59. In a case where the liquid ejection head 1 is mounted in the liquid ejection apparatus 50, the liquid connector provided at the front end of the ink supply tube 59 is connected in an air-tight manner to a liquid connector insertion port 53a that is provided in a head case 53 of the liquid ejection head 1 and that is an inlet port of the liquid. An ink supply path extending from the ink tank 2 to the liquid ejection head 1 via the external pump 21 is thereby formed. Since the four types of inks are used in the present embodiment, four sets of the ink tank 2, the external pump 21, the ink supply tube 59, and the circulation unit 54 are provided for the respective inks, and four ink supply paths for the respective inks are independently formed. As described above, the liquid ejection apparatus 50 of the present embodiment includes an ink supply system to which the inks are supplied from the ink tanks 2 provided outside the liquid ejection head 1. Note that the liquid ejection apparatus 50 of the present embodiment includes no ink collection system that collects the inks in the liquid ejection head 1 into the ink tanks 2. Accordingly, the liquid ejection head 1 is provided with the liquid connector insertion ports 53a for connection with the ink supply tubes 59 of the ink tanks 2, but is not provided with connector insertion ports for connection with tubes for collecting the inks in the liquid ejection head 1 into the ink tanks 2. Note that the liquid connector insertion ports 53a are provided for the respective inks.

In FIGS. 3A and 3B, a circulation unit for the black ink is denoted by 54B, a circulation unit for the cyan ink is denoted by 54C, a circulation unit for the magenta ink is denoted by 54M, and a circulation unit for the yellow ink is denoted by 54Y. The circulation units have substantially the same configuration. In the present embodiment, in a case where the circulation units are not particularly discriminated from one another, the circulation units are referred to as circulation units 54.

In FIGS. 2 and 3A, the ejection unit 3 includes two ejection modules 300, a first supporting member 4, a second supporting member 7, an electric wiring member (electrical-wiring tape) 5, and an electrical contact substrate 6. As illustrated in FIG. 3B, each ejection module 300 includes a silicon substrate 310 with a thickness of 0.5 to 1 mm and multiple ejection elements 15 provided on one side of the silicon substrate 310. The ejection elements 15 in the present embodiment are formed of electrothermal converting elements (heaters) that generate thermal energy as ejection energy for ejection of the liquid. Electric power is supplied to each ejection element 15 via electrical wiring formed on the silicon substrate 310 by a film forming technique.

Moreover, an ejection port formation member 320 is formed on a surface (lower surface in FIG. 3B) of the silicon substrate 310. Multiple pressure chambers 12 that correspond to the multiple ejection elements 15 and multiple ejection ports 13 from which the inks are ejected are formed in the ejection port formation member 320 by a photolithography technique. Moreover, common supply passages 18 and common collection passages 19 are formed in the silicon substrate 310. Furthermore, supply connection passages 323 that allow the common supply passages 18 and the pressure chambers 12 to communicate with one another and collection connection passages 324 that allow the common collection passages 19 and the pressure chambers 12 to communicate with one another are formed in the silicon substrate 310. In the present embodiment, one ejection module 300 is configured to eject two types of inks. Specifically, the ejection module 300 located on the left side of FIG. 3A out of the two ejection modules illustrated in FIG. 3A ejects the black ink and the cyan ink, and the ejection module 300 located on right side of FIG. 3A ejects the magenta ink and the yellow ink. Note that this combination is merely an example, and the combination of the inks may be any combination. One ejection module may be configured to eject one type of ink or eject three or more types of inks. The two ejection modules 300 do not have to eject the same number of types of inks. The ejection unit 3 may be configured to include one ejection module 300 or three or more ejection modules 300. Moreover, in the example illustrated in FIGS. 3A and 3B, two ejection port arrays extending in the Y direction are formed for one ink color. The pressure chambers 12, the common supply passage 18, and the common collection passage 19 are formed for the multiple ejection ports 13 forming each ejection port array.

Ink supply ports and ink collection ports to be described later are formed on a back surface (upper surface in FIG. 3B) of the silicon substrate 310. Each ink supply port supplies the ink from an ink supply passage 48 to the multiple common supply passages 18, and each ink collection port collects the ink from the multiple common collection passages 19 into an ink collection passage 49.

Note that the ink supply port and ink collection port described herein refers to openings for performing supply and collection of the ink in ink circulation in a forward direction to be described later. Specifically, in the ink circulation in the forward direction, the ink is supplied from the ink supply port to the common supply passages 18, and is collected from the common collection passages 19 into the ink collection port. However, ink circulation of causing the ink to flow in the reverse direction is performed in some cases. In this case, the ink is supplied from the ink collection port to the common collection passages 19 explained above, and is collected from the common supply passages 18 into the ink supply port.

As illustrated in FIG. 3A, the back surfaces (upper surfaces in FIG. 3A) of the ejection modules 300 are bonded and fixed to one surface (lower surface in FIG. 3A) of the first supporting member 4. The ink supply passages 48 and the ink collection passages 49 that penetrate the first supporting member 4 from one surface to the other surface are formed in the first supporting member 4. One openings of the ink supply passages 48 communicate with the respective ink supply ports in the silicon substrate 310 described above, and one openings of the ink collection passages 49 communicate with the respective ink collection ports in the silicon substrate 310 described above. Note that the ink supply passages 48 and the ink collection passages 49 are provided independently for the respective types of inks.

Moreover, the second supporting member 7 having openings 7a (see FIG. 2) in which the ejection modules 300 are inserted is bonded and fixed to one surface (upper surface in FIG. 3A) of the first supporting member 4. The electric wiring member 5 electrically connected to the ejection modules 300 is held on the second supporting member 7. The electric wiring member 5 is a member for applying electric signals for ink ejection to the ejection modules 300. Electrical connection portions of the ejection modules 300 and the electric wiring member 5 are sealed by a sealing material (not illustrated) to be protected from corrosion by the inks and external impact.

Moreover, the electrical contact substrate 6 is thermal compression-bonded to an end portion 5a (see FIG. 2) of the electric wiring member 5 by using a not-illustrated anisotropic conducting film, and the electric wiring member 5 and the electrical contact substrate 6 are electrically connected to each other. The electrical contact substrate 6 includes an external signal input terminal (not illustrated) for receiving electric signals from the liquid ejection apparatus 50.

In addition, a joint member 8 (FIG. 3A) is provided between the first supporting member 4 and the circulation units 54. A supply port 88 and a collection port 89 are formed in the joint member 8 for each type of ink. The supply port 88 and the collection port 89 allows the ink supply passage 48 and the ink collection passage 49 in the first supporting member 4 to communicate with passages formed in the circulation unit 54. Note that, in FIG. 3A, the supply port 88B and the collection port 89B correspond to the black ink, and the supply port 88C and the collection port 89C correspond to the cyan ink. Furthermore, the supply port 88M and the collection port 89M correspond to the magenta ink, and the supply port 88Y and the collection port 89Y correspond to the yellow ink.

Note that an opening in one end portion of each of the ink supply passages 48 and the ink collection passages 49 in the first supporting member 4 has a small opening area matching the ink supply port or the ink collection port in the silicon substrate 310. Meanwhile, an opening in the other end portion of each of the ink supply passages 48 and the ink collection passages 49 in the first supporting member 4 has such a shape that the opening area thereof is enlarged to the same opening area as a large opening area of the joint member 8 formed to match the passage of the circulation unit 54. Adopting such a configuration can suppress an increase of passage resistance for the ink collected from the collection passages. However, the shapes of the openings in the one end portion and the other end portion of each of the ink supply passages 48 and the ink collection passages 49 are not limited to the above-mentioned examples.

In the liquid ejection head 1 having the above-mentioned configuration, each ink supplied to the circulation unit 54 flows through the supply port 88 of the joint member 8 and the ink supply passage 48 of the first supporting member 4, and flows into the common supply passages 18 from the ink supply port of the ejection module 300. Then, the ink flows from the common supply passages 18 into the pressure chambers 12 via the supply connection passages 323, and part of the ink flowing into the pressure chambers is ejected from the ejection ports 13 by drive of the ejection elements 15. The remaining ink that is not ejected flows from the pressure chambers 12 through the collection connection passages 324 and the common collection passages 19, and flows into the ink collection passage 49 of the first supporting member 4 from the ink collection port. Then, the ink flowing into the ink collection passage 49 flows into the circulation unit 54 through the collection port 89 of the joint member 8 to be collected.

### <Constituent Elements of Circulation Unit>

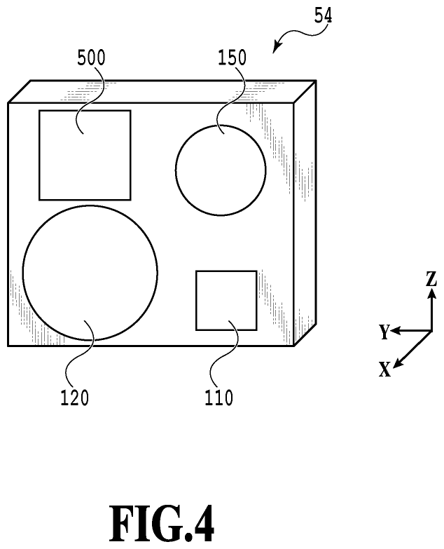

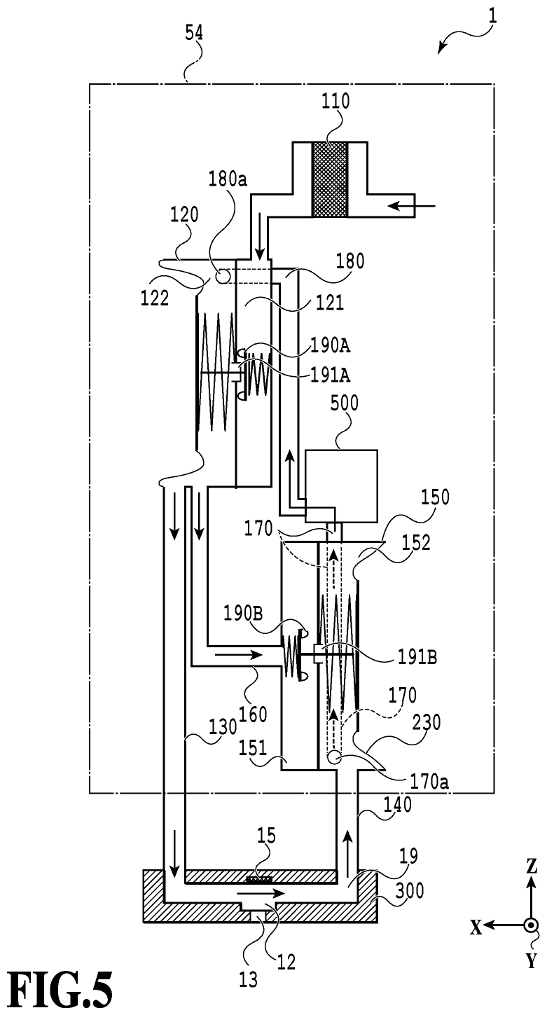

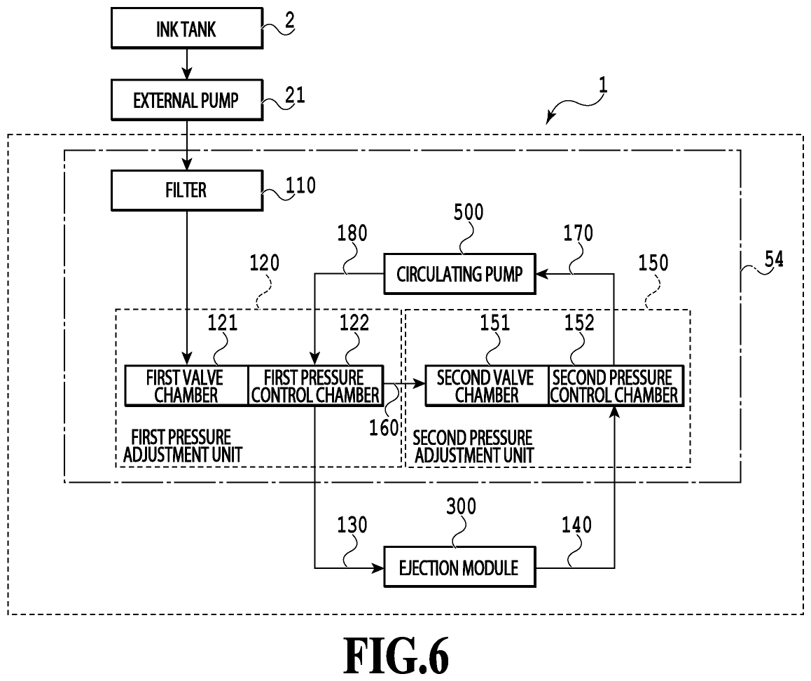

FIG. 4 is a schematic outer appearance diagram of one circulation unit 54 corresponding to one type of ink applied to the printing apparatus of the present embodiment. A filter 110, a first pressure adjustment unit 120, a second pressure adjustment unit 150, and the circulating pump 500 are arranged in the circulation unit 54. These constituent elements are connected to one another by passages as illustrated in FIGS. 5 and 6, and form a circulation path that performs supply and collection of the ink to and from the ejection module 300 in the liquid ejection head 1.

### <Circulation Path in Liquid Ejection Head>

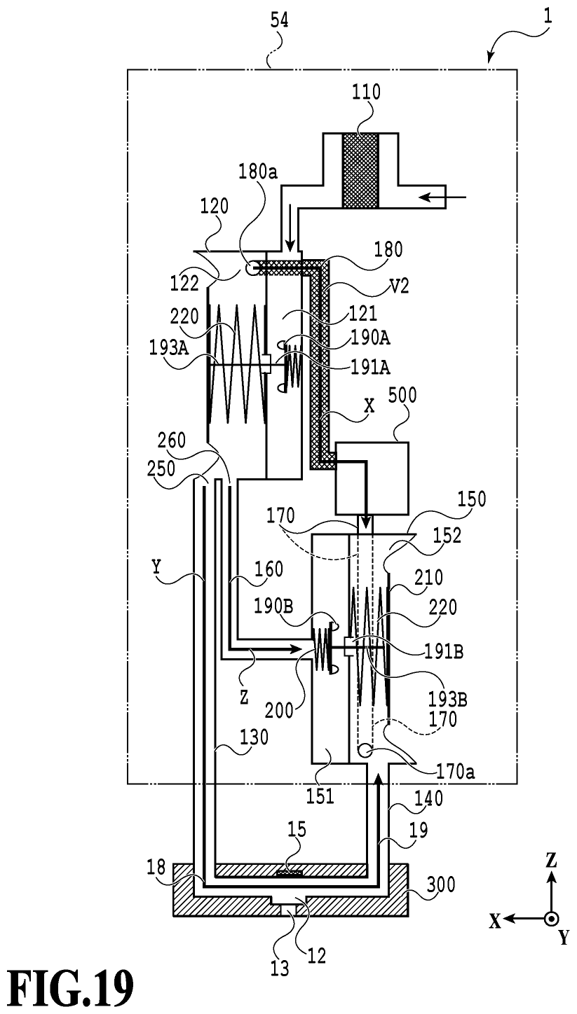

FIG. 5 is a vertical cross-sectional diagram schematically illustrating the circulation path for one type of ink (one color of ink) formed in the liquid ejection head 1. In order to explain the circulation path more clearly, positions of the respective configurations (first pressure adjustment unit 120, second pressure adjustment unit 150, circulating pump 500, and the like) relative to one another in FIG. 5 are simplified. Accordingly, the positions of the respective configurations relative to one another are different from the configurations in FIG. 19 to be described later. Moreover, FIG. 6 is a block diagram schematically illustrating the circulation path illustrated in FIG. 5. As illustrated in FIGS. 5 and 6, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured such that control pressure thereof is higher than that of the second pressure adjustment unit 150. In the present embodiment, the two pressure adjustment units 120 and 150 are used to achieve circulation within a certain pressure range in the circulation path.

Moreover, the configuration is such that the ink flows through the pressure chambers 12 (ejection elements 15) at a flow rate corresponding to a pressure difference between the first pressure adjustment unit 120 and the second pressure adjustment unit 150. The circulation path in the liquid ejection head 1 and a flow of ink in the circulation path are explained below with reference to FIGS. 5 and 6. Note that the arrows in FIGS. 5 and 6 illustrate directions of the flow of ink.

First, connection states of the constituent elements in the liquid ejection head 1 are explained.

The external pump 21 that sends the ink stored in the ink tank 2 (FIG. 6) provided outside the liquid ejection head 1 to the liquid ejection head 1 is connected to the circulation unit 54 via the ink supply tube 59 (FIG. 1). The filter 110 is provided in an ink passage located upstream of the circulation unit 54. An ink supply passage located downstream of the filter 110 is connected to the first valve chamber 121 of the first pressure adjustment unit 120. The first valve chamber 121 communicates with the first pressure control chamber 122 via a communication port 191A that can be opened and closed by a valve 190A illustrated in FIG. 5.

The first pressure control chamber 122 is connected to a supply passage 130, a bypass passage 160, and the circulating pump 500. The supply passage 130 is connected to the common supply passage 18 via the above-mentioned ink supply port provided in the ejection module 300. Moreover, the bypass passage 160 is connected to the second valve chamber 151 provided in the second pressure adjustment unit 150. The second valve chamber 151 communicates with the second pressure control chamber 152 via a communication port 191B that is opened and closed by a valve 190B illustrated in FIG. 5. Note that FIGS. 5 and 6 illustrate an example in which one end of the bypass passage 160 is connected to the first pressure control chamber 122 of the first pressure adjustment unit 120, and the other end of the bypass passage 160 is connected to the second valve chamber 151 of the second pressure adjustment unit 150. However, the configuration may be such that the one end of the bypass passage 160 is connected to the supply passage 130, and the other end of the bypass passage is connected to the second valve chamber 151.

The second pressure control chamber 152 is connected to a collection passage 140. The collection passage 140 is connected to the common collection passage 19 via the above-mentioned ink collection port provided in the ejection module 300. Moreover, the second pressure control chamber 152 is connected to the circulating pump 500 via a pump entrance passage 170. Note that, in FIG. 5, an inlet port of the pump entrance passage 170 is denoted by 170a.

Next, a flow of the ink in the liquid ejection head 1 having the above-mentioned configuration is explained. As illustrated in FIG. 6, the external pump 21 provided in the liquid ejection apparatus 50 applies pressure to the ink stored in the ink tank 2, and the ink becomes an ink flow of positive pressure to be supplied to the circulation unit 54 of the liquid ejection head 1.

The ink supplied to the circulation unit 54 passes through the filter 110, and air bubbles and foreign substances such as dust are removed from the ink. Then, the ink flows into the first valve chamber 121 provided in the first pressure adjustment unit 120. Although the pressure of the ink decreases due to a pressure loss in passing of the filter 110, the pressure of the ink at this stage is in a positive pressure state. Then, the ink flowing into the first valve chamber 121 passes through the communication port 191A, and flows into the first pressure control chamber 122 in a case where the valve 190A is in an open state. A pressure loss in the passing of the communication port 191A causes the ink flowing into the first pressure control chamber 122 to switch from positive pressure to negative pressure.

Next, a flow of the ink in the circulation path is explained. The circulating pump 500 operates to send out the ink sucked from the pump entrance passage 170 upstream of the circulating pump 500 to a pump exit passage 180 downstream of the circulating pump 500. Accordingly, the ink supplied from the first valve chamber 121 to the first pressure control chamber 122 by the drive of a supply pump (not illustrated) flows into the supply passage 130 and the bypass passage 160 together with the ink sent from the pump exit passage 180. Although details are described later, in the present embodiment, a piezoelectric diaphragm pump that uses a piezoelectric element attached to a diaphragm as a drive source is used as the circulating pump capable of sending liquid. The piezoelectric diaphragm pump is a pump that sends liquid by changing the inner volume of a pump chamber by inputting drive voltage into the piezoelectric element and causing two check valves to operate alternately by means of pressure fluctuation.

In a case where air flows into the piezoelectric diaphragm pump, the pump performance sometimes decreases due to a damping effect of air or the like. In a case where the pump performance decreases, the piezoelectric diaphragm pump cannot exert a necessary circulation flow rate, and ejection stability may decrease. In order to prevent this, as illustrated in FIG. 5, the pump inlet 170a of the pump entrance passage 170 is desirably provided at a position as low as possible in the second pressure control chamber 152, and is not exposed out from the ink.

Moreover, as illustrated in FIG. 5, a pump outlet 180a of the pump exit passage 180 is desirably provided on the upper portion of the first pressure control chamber 122. This generates a flow of ink from the upper portion to the lower portion in the first pressure control chamber 122, and precipitation due to stagnation of the ink can thereby suppressed.

Moreover, in a case where precipitation progresses to a certain level during stop of circulation, operating the circulating pump 500 causes thick ink accumulated in a lower portion of the first pressure control chamber 122 to be carried to the second pressure control chamber 152, and the ink is sucked from the pump inlet 170a provided in a lower portion of the second pressure control chamber 152.

The liquid ejection head 1 is configured to bring the ink closer to a uniform concentration by ejecting this relatively thick ink to a relatively thin ink in the upper portion of the first pressure control chamber 122.

The ink flowing into the supply passage 130 flows from the ink supply port of the ejection module 300 into the pressure chambers 12 via the common supply passage 18, and part of the flowing ink is ejected from the ejection ports 13 by drive (heating) of the ejection elements 15. Meanwhile, the remaining ink not used in the ejection flows out the pressure chambers 12, passes the common collection passage 19, and then flows into the collection passage 140 connected to the ejection module 300. The ink flowing into the collection passage 140 flows into the second pressure control chamber 152 of the second pressure adjustment unit 150.

Meanwhile, the ink flowing from the first pressure control chamber 122 into the bypass passage 160 flows into the second valve chamber 151, and then flows into the second pressure control chamber 152 by passing through the communication port 191B. The ink flowing into the second pressure control chamber 152 via the bypass passage 160 and the ink collected from the collection passage 140 are sucked into the circulating pump 500 via the pump entrance passage 170 by the drive of the circulating pump 500. Then, the ink sucked into the circulating pump 500 is sent to the pump exit passage 180, and flows into the first pressure control chamber 122 again. Thereafter, the ink flowing from the first pressure control chamber 122 into the second pressure control chamber 152 via the supply passage 130 and the ejection module 300 and the ink flowing into the second pressure control chamber 152 via the bypass passage 160 flow into the circulating pump 500. Then, the ink is sent from the circulating pump 500 to the first pressure control chamber 122. The circulation of the ink in the circulation path is thus performed.

In this example, the passage that allows the first pressure adjustment unit 120 and the pressure chambers 12 to communicate with one another is referred to as upstream passage, and the passages that allow the pressure chambers 12 and the circulating pump 500 to communicate with one another is referred to as downstream passage. Specifically, the supply passage 130 is referred to as upstream passage, and the collection passage 140, the second pressure adjustment unit 150, and the pump entrance passage 170 are collectively referred to as downstream passage. Note that the downstream passage does not have to include the second pressure adjustment unit 150 and the pump entrance passage 170. Moreover, the pump exit passage 180 is also referred to as intermediate passage. Accordingly, in the present embodiment, the liquid flows through in the order of the circulating pump 500, the intermediate passage, the first pressure adjustment unit 120, the upstream passage, the pressure chambers 12, the downstream passage, and the circulation path of the circulating pump 500. Moreover, the supply passage 130 is also referred to as first passage, the collection passage 140 is also referred to as second passage, the pump entrance passage 170 is also referred to as third passage, and the pump exit passage 180 is also referred to as fourth passage.

As described above, in the present embodiment, it is possible to circulate the liquid along the circulation path formed in the liquid ejection head 1 with the circulating pump 500. Accordingly, thickening of the ink and sedimentation of a precipitation content of ink in a color material can be suppressed in the ejection module 300, and the flowability of the ink and ejection characteristics at the ejection ports can be maintained in good condition in the ejection module 300.

Moreover, the circulation path in the present embodiment adopts a configuration in which the circulation path completes within the liquid ejection head 1. Accordingly, the length of the circulation path can be greatly reduced from that in a case where the ink is circulated between the liquid ejection head 1 and the ink tank 2 provided outside the liquid ejection head. Accordingly, the ink can be circulated with a small circulating pump.

Moreover, the connection passage of the liquid ejection head 1 and the ink tank 2 is configured to include only the passage that supplies the ink. Specifically, the present embodiment adopts a configuration that requires no passage for collecting the ink from the liquid ejection head 1 into the ink tank 2. Accordingly, the connection between the ink tank 2 and the liquid ejection head 1 requires only the tube for ink supply, and requires no tube for ink collection. This allows the inside of the liquid ejection apparatus 50 to have a simple configuration in which the number of tubes is reduced, and can achieve size reduction of the entire apparatus. Moreover, reduction of the number of tubes can reduce pressure fluctuation of the ink caused by swinging of the tube with the main scanning of the liquid ejection head 1. Furthermore, the swinging of the tube in the main scanning of the liquid ejection head 1 becomes a drive load of the carriage motor that drives the carriage 60. Accordingly, reduction of the number of tubes reduces the drive load of the carriage motor, and allows simplification of a main scanning mechanism including the carriage motor and the like. Moreover, since collection of the ink from the liquid ejection head to the ink tank is not required, the size the external pump 21 can be reduced. As described above, according to the present embodiment, it is possible to achieve size reduction and cost reduction of the liquid ejection apparatus 50.

### <Pressure Adjustment Unit>

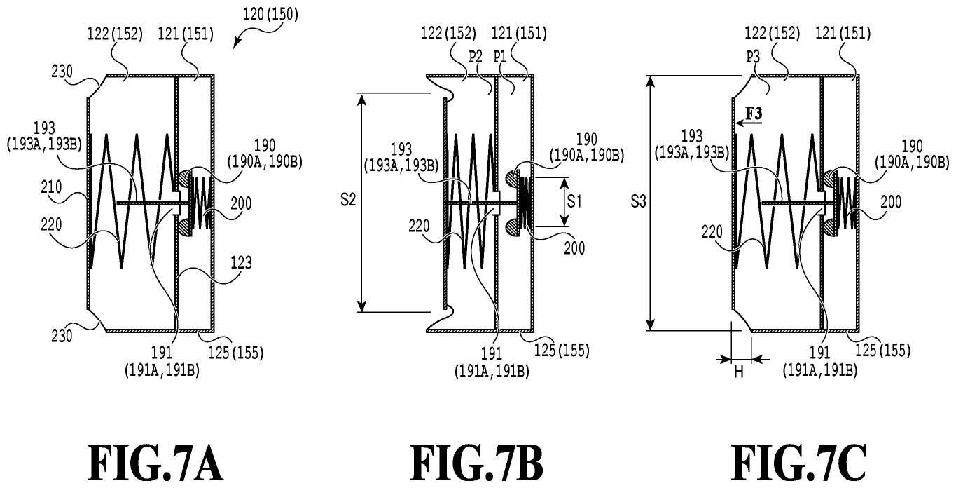

FIGS. 7A to 7C are diagrams illustrating an example of the pressure adjustment units. Configurations and actions of the pressure adjustment units (first pressure adjustment unit 120 and second pressure adjustment unit 150) included in the above-mentioned liquid ejection head 1 are explained below in further detail with reference to FIGS. 7A to 7C. Note that the first pressure adjustment unit 120 and the second pressure adjustment unit 150 have substantially the same configuration. Accordingly, explanation is given below by using the first pressure adjustment unit 120 as an example, and explanation of the second pressure adjustment unit 150 is substituted by adding reference numerals for the second pressure adjustment unit 150 to reference numerals for the first pressure adjustment unit 120 in FIGS. 7A to 7C. In a case of the second pressure adjustment unit 150, the first valve chamber 121 explained below is read as the second valve chamber 151, and the first pressure control chamber 122 is read as the second pressure control chamber 152.

The first pressure adjustment unit 120 includes the first valve chamber 121 and the first pressure control chamber 122 formed in a cylindrical case 125. The first valve chamber 121 and the first pressure control chamber 122 are partitioned from each other by a partition 123 provided in the cylindrical case 125. Note that the first valve chamber 121 communicates with the first pressure control chamber 122 via the communication port 191 formed in the partition 123. The first valve chamber 121 is provided with the valve 190 that switches a state of the first valve chamber 121 and the first pressure control chamber 122 at the communication port 191 between a communicating state and a blocked state. The valve 190 is in such a configuration that the valve 190 is maintained at a position where the valve 190 faces the communication port 191 by a valve spring 200, and the valve 190 can be brought into tight contact with the partition 123 by biasing force of the valve spring 200. Bringing the valve 190 into tight contact with the partition 123 blocks the flow of ink in the communication port 191. Note that, in order to improve a tight-contact property with the partition 123, a contact portion of the valve 190 with the partition 123 is preferably made of an elastic material. Moreover, a valve shaft 193A inserted into the communication port 191 is protruded from a center portion of the valve 190. Pressing the valve shaft 193A against the biasing force of the valve spring 200 causes the valve 190 to separate from the partition 123, and the flow of ink in the communication port 191 becomes possible. Hereinafter, a state where the valve 190 blocks the flow of ink in the communication port 191 is referred to as “closed state”, and a state where the valve 190 allows the flow of ink in the communication port 191 is referred to as “open state”.

An opening portion of the cylindrical case 125 is closed by a flexible member 230 and a pressure plate 210. The flexible member 230, the pressure plate 210, a peripheral wall of the case 125, and the partition 123 form the first pressure control chamber 122. The pressure plate 210 is configured to be displaceable with displacement of the flexible member 230. Although the materials of the pressure plate 210 and the flexible member 230 are not limited to particular materials, for example, the materials may be such that the pressure plate 210 is formed of a resin molded part and the flexible member 230 is formed of a resin film. In this case, the pressure plate 210 can be fixed to the flexible member 230 by thermal welding.

A pressure adjustment spring 220 (biasing member) is provided between the pressure plate 210 and the partition 123. As illustrated in FIG. 7A, the pressure plate 210 and the flexible member 230 are biased by biasing force of the pressure adjustment spring 220 in such a direction that the inner volume of the first pressure control chamber 122 increases. Moreover, in a case where the pressure in the first pressure control chamber 122 decreases, the pressure plate 210 and the flexible member 230 are displaced in such a direction that the inner volume of the first pressure control chamber 122 decreases, against the pressure of the pressure adjustment spring 220. Then, in a case where the inner volume of the first pressure control chamber 122 decreases to a certain volume, the pressure plate 210 abuts the valve shaft 193A of the valve 190. In a case where the inner volume of the first pressure control chamber 122 further decreases thereafter, the valve 190 moves together with the valve shaft 193A pressed by the pressure plate 210 against the biasing force of the valve spring 200, and separates from the partition 123. The communication port 191 thereby switches to the open state (state of FIG. 7B).

In the present embodiment, connection in the circulation path is set such that the pressure in the first valve chamber 121 in a case where the communication port 191 switches to the open state is higher than the pressure in the first pressure control chamber 122. This allows the ink to flow from the first valve chamber 121 into the first pressure control chamber 122 in a case where the communication port 191 switches to the open state. This ink flow-in causes the flexible member 230 and the pressure plate 210 to be displaced in such a direction that the inner volume of the first pressure control chamber 122 increases. As a result, the pressure plate 210 separates from the valve shaft 193A of the valve 190, the valve 190 is brought into tight contact with the partition 123 by the biasing force of the valve spring 200, and the communication port 191 switches to the closed state (state of FIG. 7C).

As described above, the first pressure adjustment unit 120 according to the present embodiment is configured as follows. The ink flows from the first valve chamber 121 into the first pressure control chamber 122 via the communication port 191 in a case where the pressure in the first pressure control chamber 122 reaches or falls below certain pressure (for example, in a case where negative pressure increases). Accordingly, there is no further decrease of the pressure in the first pressure control chamber 122. Thus, the pressure in the first pressure control chamber 122 is controlled to be maintained within a certain range.

Next, the pressure in the first pressure control chamber 122 is explained in further detail.

Assume a case where the flexible member 230 and the pressure plate 210 are displaced according to the pressure of the first pressure control chamber 122, and the pressure plate 210 abuts the valve shaft 193A to switch the communication port 191 to the open state (state of FIG. 7B) as described above. A relationship of forces acting on the pressure plate 210 in this case can be expressed by the following formula 1.

$$P 2 \times S 2 + F 2 + ( P 1 - P 2 ) \times S 1 + F 1 = 0 \qquad Formula 1$$

Then, the formula 1 is simplified for P2 as follows.

$$P 2 = - ( F 1 + F 2 + P 1 \times S 1 ) / ( S 2 - S 1 ) \qquad Formula 2$$

P1: pressure (gauge pressure) in first valve chamber 121
P2: pressure (gauge pressure) in first pressure control chamber 122
F1: spring force of valve spring 200
F2: spring force of pressure adjustment spring 220
S1: pressure receiving area of valve 190
S2: pressure receiving area of pressure plate 210

In this case, the spring force F1 of the valve spring 200 and the spring force F2 of the pressure adjustment spring 220 are defined such that the direction in which these springs press the valve 190 and the pressure plate 210 (rightward in FIGS. 7A to 7C) is positive. Moreover, regarding the pressure P1 in the first valve chamber 121 and the pressure P2 in the first pressure control chamber 122, the configuration is such that P1 has a relationship of P1≥P2.

Adopting the configuration in which the pressure P2 in the first pressure control chamber 122 in a case where the communication port 191 switches to the open state is determined by the formula 2. In a case where the communication port 191 switches to the open state, the ink to flow from the first valve chamber 121 into the first pressure control chamber 122 because the relationship of P1≥P2 is achieved. As a result, there is no further decrease of the pressure P2 in the first pressure control chamber 122, and P2 is maintained at pressure within the certain range.

Meanwhile, a relationship of forces acting on the pressure plate 210 in a case where the pressure plate 210 switches to the state not abutting the valve shaft 193A and the communication port 191B switches to the closed state as illustrated in FIG. 7C is as expressed in the formula 3.

$$P 3 \times S 3 + F 3 = 0 \qquad Formula 3$$

Then, the formula 3 is simplified for P3 as follows.

$$P 3 = - F 3 / S 3 \qquad Formula 4$$

F3: spring force of pressure adjustment spring 220 in case where pressure plate 210 and valve shaft 193A are in not-abutting state
P3: pressure (gauge pressure) in first pressure control chamber 122 in case where pressure plate 210 and valve shaft 193A are in not-abutting state
S3: pressure receiving area of pressure plate 210 in case where pressure plate 210 and valve 190 are in not-abutting state

FIG. 7C illustrates a state where the pressure plate 210 and the flexible member 230 are displaced leftward in FIG. 7C up to a displaceable limit. The pressure P3 in the first pressure control chamber 122, the spring force F3 of the pressure adjustment spring 220, and the pressure receiving area S3 of the pressure plate 210 change depending on a displacement amount during displacement of the pressure plate 210 and the flexible member 230 to the state of FIG. 7C. Specifically, in a case where the pressure plate 210 and the flexible member 230 are located further to the right in FIGS. 7A to 7C as compared to a position in FIG. 7C, the pressure receiving area S3 of the pressure plate 210 is smaller, and the spring force F3 of the pressure adjustment spring 220 is larger. As a result, the pressure P3 of the first pressure control chamber 122 is smaller (negative pressure is higher) according to the relationship of the formula 4. Thus, in a period of change from the state of FIG. 7B to the state of FIG. 7C, the pressure in the first pressure control chamber 122 gradually increases (that is the negative pressure decreases and the value of pressure becomes closer to the positive pressure side) according to the formulae 2 and 4. Specifically, the pressure plate 210 and the flexible member 230 are gradually displaced leftward from the state where the communication port 191B is in the open state, and the pressure in the first pressure control chamber gradually increases until the inner volume of the first pressure control chamber 122 eventually reaches the displaceable limit. In other words, the negative pressure decreases.

In the present embodiment, the first pressure adjustment unit 120 adjusts the pressure of the liquid in the upstream passage, and the second pressure adjustment unit 150 adjusts the pressure of the liquid in the pump entrance passage 170 (entrance passage).

### <Circulating Pump>

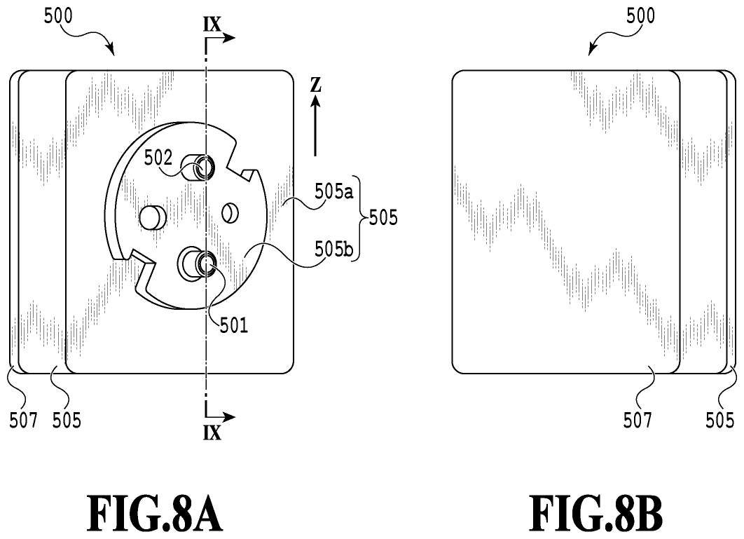

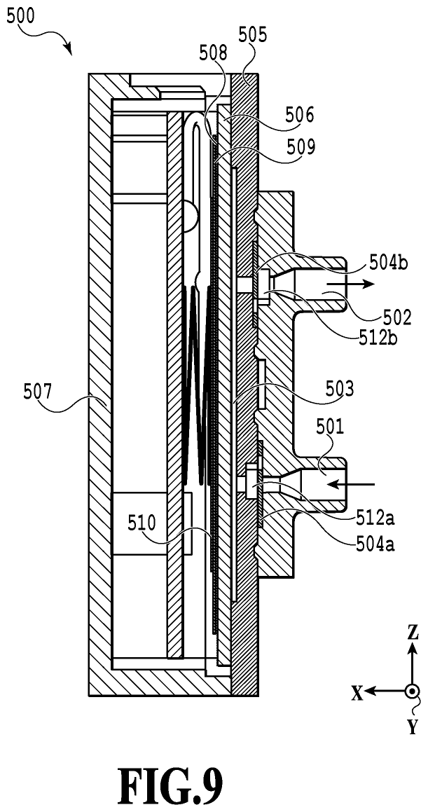

Next, configurations and actions of the circulating pump 500 included in the above-mentioned liquid ejection head 1 are explained in detail with reference to FIGS. 8A and 8B and FIG. 9.

FIGS. 8A and 8B are external appearance perspective diagrams of the circulating pump 500. FIG. 8A is an external appearance perspective diagram illustrating the front side of the circulating pump 500, and FIG. 8B is an external appearance perspective diagram illustrating the back side of the circulating pump 500. An outer shell of the circulating pump 500 is formed of a pump case 505 and a cover 507 fixed to the pump case 505. The pump case 505 is formed of a case main body 505a and a passage connection member 505b bonded and fixed to an outer surface of the case main body 505a. Pairs of through-holes provided respectively in a case main body 505a and the passage connection member 505b and communicating with each other are provided at two locations. The pair of through-holes provided at one location forms a pump supply hole 501, and the pair of through-holes provided at the other location forms a pump discharge hole 502. The pump supply hole 501 is connected to the pump entrance passage 170 connected to the second pressure control chamber 152, and the pump discharge hole 502 is connected to the pump exit passage 180 connected to the first pressure control chamber 122. The ink supplied from the pump supply hole 501 passes through a pump chamber 503 (see FIG. 9) to be described later, and is discharged from the pump discharge hole 502.

FIG. 9 is a cross-sectional diagram of the circulating pump 500 illustrated in FIG. 8A along the IX-IX line. A diaphragm 506 is joined to an inner surface of the pump case 505, and the pump chamber 503 is formed between the diaphragm 506 and a recess portion formed on the inner surface of the pump case 505. The pump chamber 503 communicates with the pump supply hole 501 and the pump discharge hole 502 formed in the pump case 505. Moreover, a check valve 504a is provided in an intermediate portion of the pump supply hole 501, and a check valve 504b is provided in an intermediate portion of the pump discharge hole 502. In other words, the circulating pump 500 includes check valves in a passage that allows the downstream passage and the intermediate passage to communicate with each other. Specifically, the check valve 504a is arranged such that a part thereof can move leftward in FIG. 9 in a space 512a formed in the intermediate portion of the pump supply hole 501. Moreover, the check valve 504b is arranged such that a part thereof can move rightward in FIG. 9 in a space 512b formed in the intermediate portion of the pump discharge hole 502.

In a case where the diaphragm 506 is displaced and the inner volume of the pump chamber 503 increases to cause depressurization of the pump chamber 503, the check valve 504a is separated from an opening of the pump supply hole 501 in the space 512a (that is moved leftward in FIG. 9). Separation of the check valve 504a from the opening of the pump supply hole 501 in the space 512a causes the check valve 504a to switch to an open state in which the check valve 504a allows the flow of ink in the pump supply hole 501. Moreover, in a case where the diaphragm 506 is displaced and the inner volume of the pump chamber 503 decreases to cause pressurization of the pump chamber 503, the check valve 504a is brought into tight contact with a wall surface around the opening of the pump supply hole 501. As a result, the check valve 504a switches to a closed state in which the check valve 504a blocks the flow of ink in the pump supply hole 501.

Meanwhile, in a case where the pump chamber 503 is depressurized, the check valve 504b is brought into tight contact with a wall surface around an opening of the pump case 505, and switches to a closed state in which the flow of ink in the pump discharge hole 502 is blocked. Moreover, in a case where the pump chamber 503 is pressurized, the check valve 504b is separated from the opening of the pump case 505, and is moved toward the space 512b (that is moved rightward in FIG. 9) to allow the flow of ink in the pump discharge hole 502.

Note that the material of each of the check valves 504a and 504b may be any material that can deform depending on the pressure in the pump chamber 503, and may be formed of, for example, an elastic member of EPDM, elastomer, or the like or a film or a thin plate of polypropylene or the like. However, the material is not limited to these materials.

As described above, the pump chamber 503 is formed by joining the pump case 505 and the diaphragm 506. Accordingly, deformation of the diaphragm 506 causes the pressure in the pump chamber 503 to change. For example, in a case where the diaphragm 506 is displaced toward the pump case 505 (displaced rightward in FIG. 9) and the inner volume of the pump chamber 503 decreases, the pressure in the pump chamber 503 increases. This switches the check valve 504b arranged to face the pump discharge hole 502 to the open state, and the ink in the pump chamber 503 is discharged. In this case, the check valve 504a arranged to face the pump supply hole 501 is brought into tight contact with the wall surface around the pump supply hole 501. Accordingly, backflow of the ink from the pump chamber 503 to the pump supply hole 501 is suppressed.

On the other hand, in a case where the diaphragm 506 is displaced in such a direction that the pump chamber 503 expands, the pressure in the pump chamber 503 decreases. This switches the check valve 504a arranged to face the pump supply hole 501 to the open state, and the ink is supplied to the pump chamber 503. In this case, the check valve 504b arranged in the pump discharge hole 502 is brought into tight contact with the wall surface around the opening formed in the pump case 505, and closes this opening. Accordingly, backflow of the ink from the pump discharge hole 502 to the pump chamber 503 is suppressed.

As described above, the circulating pump 500 performs suction and discharge of the ink by deforming the diaphragm 506 and changing the pressure in the pump chamber 503. If bubbles are mixed into the pump chamber 503 in this case, the pressure change in the pump chamber 503 becomes small even in a case where the diaphragm 506 is displaced due to expansion and contraction of the bubbles, and the liquid sending amount decreases. Accordingly, the pump chamber 503 is arranged parallel to gravity so that the bubbles mixed in the pump chamber 503 tend to gather in an upper portion of the pump chamber 503. Moreover, the pump discharge hole 502 is arranged above the center of the pump chamber 503. This can improve a discharge property of bubbles in the pump, and stabilize the flow rate.

### <Flow of Ink in Liquid Ejection Head>

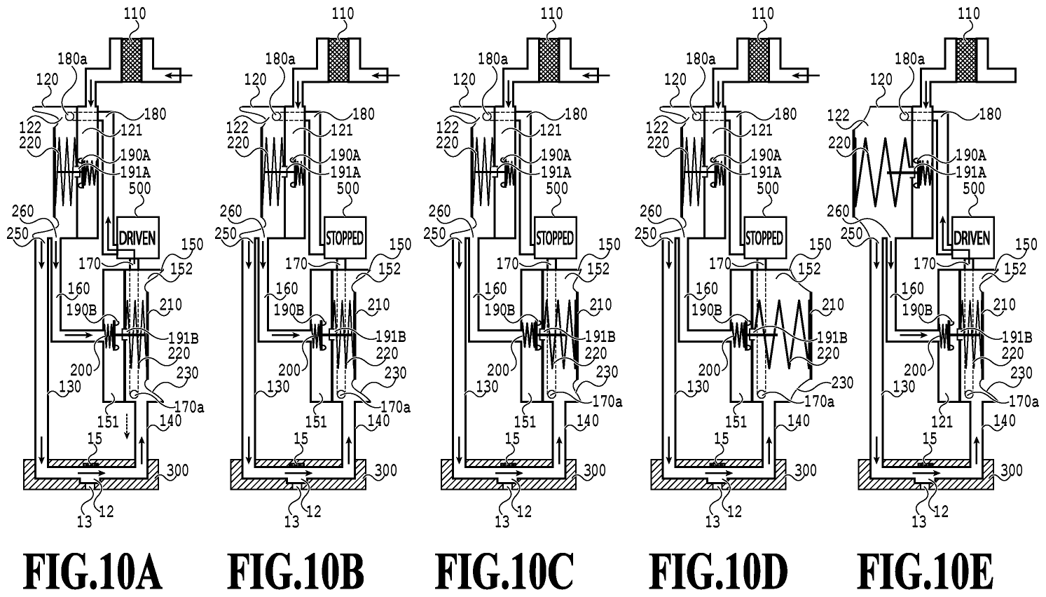

FIGS. 10A to 10E are diagrams explaining flows of ink in the liquid ejection head. Circulation of ink performed in the liquid ejection head 1 is explained with reference to FIGS. 10A to 10E. Positions of the respective configurations (first pressure adjustment unit 120, second pressure adjustment unit 150, circulating pump 500, and the like) in FIGS. 10A to 10E relative to one another are simplified to explain the ink circulation path more clearly. Accordingly, the positions of the respective configurations relative to one another are different from the configurations of FIG. 19 to be described later. FIG. 10A is a diagram schematically illustrating a flow of ink in a print operation in which printing is performed by ejecting the ink from the ejection port 13. Note that the arrows in FIGS. 10A to 10E illustrate the flow of ink. In the present embodiment, drive of both of the external pump 21 and the circulating pump 500 is started in a case where the print operation is performed. Note that the external pump 21 and the circulating pump 500 may be driven irrespective of the print operation. Furthermore, the external pump 21 and the circulating pump 500 do not have to be driven in conjunction, and may be separately and independently driven.

During the print operation, the circulating pump 500 is in the ON state (drive state), and the ink flowing out from the first pressure control chamber 122 flows into the supply passage 130 and the bypass passage 160. The ink flowing into the supply passage 130 passes through the ejection module 300, then flows into the collection passage 140, and is thereafter supplied to the second pressure control chamber 152.

Meanwhile, the ink flowing from the first pressure control chamber 122 into the bypass passage 160 flows into the second pressure control chamber 152 via the second valve chamber 151. The ink flowing into the second pressure control chamber 152 passes through the pump entrance passage 170, the circulating pump 500, and the pump exit passage 180, and then flows into the first pressure control chamber 122 again. In this case, the pressure in the first valve chamber 121 is set to be higher than the control pressure of the first pressure control chamber 122 based on the relationship of the formula 2 described above. Accordingly, the ink in the first pressure control chamber 122 is supplied to the ejection module 300 again via the supply passage 130 without flowing to the first valve chamber 121. The ink flowing into the ejection module 300 flows through the collection passage 140, the second pressure control chamber 152, the pump entrance passage 170, the circulating pump 500, and the pump exit passage 180, and flows into the first pressure control chamber 122 again. Moreover, the rest of the ink in the first pressure control chamber 122 flows through the bypass passage 160, the second valve chamber 151, the second pressure control chamber 152, the pump entrance passage 170, the circulating pump 500, and the pump exit passage 180, and flows into the first pressure control chamber 122 again. The ink circulation that completes within the liquid ejection head 1 is thus performed.

In the above ink circulation, a circulation amount (flow rate) of the ink in the ejection module 300 is determined by a pressure difference between the control pressure in the first pressure control chamber 122 and the control pressure in the second pressure control chamber 152. This pressure difference is set to achieve such a circulation amount that thickening of the ink near the ejection ports in the ejection module 300 can be suppressed. Moreover, the ink is supplied from the ink tank 2 to the first pressure control chamber 122 via the filter 110 and the first valve chamber 121 by an amount corresponding to the ink consumed by printing. A system of supplying the consumed ink is explained in detail. A decrease of the ink in the circulation path by the amount corresponding to the amount of ink consumed by the printing causes the pressure in the first pressure control chamber to decrease, and the ink in the first pressure control chamber 122 also resultantly decreases. The inner volume of the first pressure control chamber 122 decreases with the decrease of the ink in the first pressure control chamber 122. This decrease in the inner volume of the first pressure control chamber 122 switches the communication port 191A to the open state, and the ink is supplied from the first valve chamber 121 to the first pressure control chamber 122. A pressure loss is generated in a case where this supplied ink flows from the first valve chamber 121 and passes through the communication port 191A. Then, flowing of the ink into the first pressure control chamber 122 switches the positive pressure ink to a negative pressure state. Thereafter, an increase in the pressure in the first pressure control chamber 122 caused by the flowing of the ink from the first valve chamber 121 into the first pressure control chamber 122 causes the inner volume of the first pressure control chamber 122 to increase, and the communication port 191A switches to the closed state. As described above, the communication port 191A repeatedly switches to the open state and the closed state depending on the ink consumption. Meanwhile, in a case where the ink is not consumed, the communication port 191A is maintained in the closed state.

FIG. 10B is a diagram schematically illustrating a flow of ink just after a time point where the print operation is completed and the circulating pump 500 is set to the OFF state (stop state). At the time point where the print operation is completed and the circulating pump 500 is turned OFF, the pressure in the first pressure control chamber 122 and the pressure in the second pressure control chamber 152 are both the control pressures in the print operation. Accordingly, the ink moves as illustrated in FIG. 10B depending on the pressure difference between the pressure in the first pressure control chamber 122 and the pressure in the second pressure control chamber 152. Specifically, a flow of ink in which the ink is supplied from the first pressure control chamber 122 to the ejection module 300 via the supply passage 130 and then reaches the second pressure control chamber 152 via the collection passage 140 continues to occur. Moreover, a flow of ink from the first pressure control chamber 122 to the second pressure control chamber 152 via the bypass passage 160 and the second valve chamber 151 also continues to occur.

The same amount of ink as the ink moving from the first pressure control chamber 122 to the second pressure control chamber 152 by these ink flows is supplied from the ink tank 2 to the first pressure control chamber 122 via the filter 110 and the first valve chamber 121. Accordingly, the content of the first pressure control chamber 122 is maintained constant. In a case where the content of the first pressure control chamber 122 is constant, the spring force F1 of the valve spring 200, the spring force F2 of the pressure adjustment spring 220, the pressure receiving area S1 of the valve 190, and the pressure receiving area S2 of the pressure plate 210 are maintained constant from the relationship of the formula 2 described above. Accordingly, the pressure in the first pressure control chamber 122 is determined depending on the change in the pressure (gauge pressure) P1 in the first valve chamber 121. Thus, in a case where there is no change in the pressure P1 in the first valve chamber 121, the pressure P2 in the first pressure control chamber 122 is maintained at the same pressure as the control pressure during the print operation. In the state illustrated in FIG. 10B, since the second communication port 191B is in the open state and the second pressure plate 210B and the second valve 190B are in the abutting state, the pressure in the second pressure control chamber 152 changes according to the formula 2.

Meanwhile, the pressure in the second pressure control chamber 152 changes over time depending on a change in content that occurs with the flowing-in of the ink from the first pressure control chamber 122. Specifically, the pressure in the second pressure control chamber 152 changes according to the formula 2 in a period which ends at the time when the liquid ejection head 1 changes from the state of FIG. 10B to a state where the communication port 191B switches to the closed state and the second valve chamber 151 and the second pressure control chamber 152 switch to a non-communicating state as illustrated in FIG. 10C. Thereafter, the pressure plate 210 and the valve shaft 193B switch to the not-abutting state, and the communication port 191B switches to the closed state. Then, as illustrated in FIG. 10D, the ink flows from the collection passage 140 into the second pressure control chamber 152. This ink flow-in displaces the pressure plate 210 and the flexible member 230, and the pressure in the second pressure control chamber 152 changes according to the formula 4 until the inner volume of the second pressure control chamber 152 reaches the maximum volume. In other words, the pressure increases.

Note that, in the state of FIG. 10C, no flow of ink from the first pressure control chamber 122 to the second pressure control chamber 152 via the bypass passage 160 and the second valve chamber 151 occurs. Accordingly, only the flow in which the ink in the first pressure control chamber 122 is supplied to the ejection module 300 via the supply passage 130 and then reaches the second pressure control chamber 152 via the collection passage 140 occurs.

As described above, movement of the ink from the first pressure control chamber 122 to the second pressure control chamber 152 occurs depending on the pressure difference between the pressure in the first pressure control chamber 122 and the pressure in the second pressure control chamber 152. Accordingly, movement of the ink stops when the pressure in the second pressure control chamber 152 becomes equal to the pressure in the first pressure control chamber 122.

Moreover, in the state where the pressure in the second pressure control chamber 152 is equal to the pressure in the first pressure control chamber 122, the second pressure control chamber 152 expands to the state illustrated in FIG. 10D. In a case where the second pressure control chamber 152 expands as illustrated in FIG. 10D, a reservoir portion capable of reserving the ink is formed in the second pressure control chamber 152. Note that time of transition from the stop of the circulating pump 500 to the state of FIG. 10D may vary depending on the shape and size of the passage and the properties of the ink, and is roughly about one to two minutes. In a case where the circulating pump 500 is driven from the state illustrated in FIG. 10D in which the ink is reserved in the reservoir portion, the ink in the reservoir portion formed in the second pressure control chamber 152 is supplied to the first pressure control chamber 122 by the circulating pump 500. The ink amount in the first pressure control chamber 122 thereby increases as illustrated in FIG. 10E, and the flexible member 230 and the pressure plate 210 of the first pressure adjustment unit 120 are displaced in an expanding direction. Then, in a case where the circulating pump 500 is continuously driven, the state in the circulation path changes to the state as illustrated in FIG. 10A.

Note that, although FIG. 10A is explained as an example in the print operation in the above explanation, the circulation of ink may be performed without the print operation as described above. Also in this case, the ink circulation path transitions as illustrated in FIG. 10A to FIG. 10E depending on the drive and stop of the circulating pump 500.

Moreover, as described above, the present embodiment uses an example in which the communication port 191B in the second pressure adjustment unit 150 switches to the open state in a case where the circulating pump 500 is driven and the ink is circulated, and switches to the closed state in a case where the circulation of ink is stopped. However, the configuration is not limited to this. The control pressure may be set such that the communication port 191B in the second pressure adjustment unit 150 is in the closed state also in a case where the circulating pump 500 is driven and the ink is circulated. Specific explanation is given below with explanation of a role of the bypass passage 160.

The bypass passage 160 that connects the first pressure adjustment unit 120 and the second pressure adjustment unit 150 is provided to prevent the negative pressure generated in the circulation path from affecting the ejection module 300 in a case where the negative pressure exceeds a predetermined value. Moreover, the bypass passage 160 is provided to supply the ink from both of the supply passage 130 side and the collection passage 140 side to the pressure chamber 12.

First, explanation is given of an example in which the bypass passage 160 is provided to prevent the negative pressure from affecting the ejection module 300 in a case where the negative pressure exceeds the predetermined value. For example, characteristics (for example, viscosity) of the ink sometimes change depending on a change in environment temperature. In a case where the viscosity of ink changes, the pressure loss in the circulation path also changes. For example, in a case where the viscosity of the ink decreases, the pressure loss in the circulation path decreases. As a result, the flow rate of the circulating pump 500 driven at a constant drive amount increases, and the flow rate of the ink flowing in the ejection module 300 increases. Meanwhile, since the ejection module 300 is maintained at constant temperature by a not-illustrated temperature adjustment mechanism, the viscosity of ink in the ejection module 300 is maintained constant even in a case where the environment temperature changes. Since the flow rate of the ink flowing in the ejection module 300 increases while there is no change in the viscosity of the ink in the ejection module 300, the negative pressure in the ejection module 300 increases by an amount corresponding to the increase in the flow rate due to flow resistance. In a case where the negative pressure in the ejection module 300 exceeds the predetermined value as described above, there is a possibility that a meniscus in the ejection port 13 are destroyed, and outside air is pulled into the circulation path. In this case, execution of normal ejection may not be possible. Moreover, even in a case where the meniscus is not destroyed, there is a possibility that the negative pressure in the pressure chamber 12 exceeds a predetermined level and affects the ejection.

Accordingly, the bypass passage 160 is formed in the circulation path in the present embodiment. Providing the bypass passage 160 causes the ink to flow also to the bypass passage 160 in a case where the negative pressure exceeds the predetermined value, and the pressure in the ejection module 300 can be thereby maintained constant. Accordingly, for example, the control pressure may be set such that the communication port 191B in the second pressure adjustment unit 150 is maintained in the closed state also during the drive of the circulating pump 500. Moreover, the control pressure in the second pressure adjustment unit may be set such that the communication port 191B in the second pressure adjustment unit 150 switches to the open state in a case where the negative pressure exceeds the predetermined value. Specifically, the communication port 191B may be in the closed state in a case where the circulating pump 500 is driven as long as a predetermined level of negative pressure is maintained or the meniscus is not destroyed by the flow rate change of the pump due to the viscosity change caused by an environment change or the like.

Next, explanation is given of an example in which the bypass passage 160 is provided to supply the ink from both of the supply passage 130 side and the collection passage 140 side to the pressure chamber 12. Pressure fluctuation in the circulation path may occur also due to the ejection operation of the ejection element 15. This is because force that pulls the ink into the pressure chamber is generated with the ejection operation.

Explanation is given below of a point where the ink supplied to the pressure chamber 12 is supplied from both of the supply passage 130 side and the collection passage 140 side in a case where high-duty printing is continued. Note that although the definition of duty may change depending on various conditions, in this case, duty is assumed to be such that a state where one ink droplet of 4 pl is printed on a lattice of 1200 dpi is 100%. The high-duty printing is assumed to be printing performed at a duty of, for example, 100%.

In a case where the high-duty printing is continued, the amount of ink flowing from the pressure chamber 12 into the second pressure control chamber 152 via the collection passage 140 decreases. Meanwhile, since the circulating pump 500 causes the ink to flow out at a constant flow rate, a balance between flow-in rate and flow-out rate in the second pressure control chamber 152 is lost, the ink in the second pressure control chamber 152 decreases, the negative pressure in the second pressure control chamber 152 increases, and the second pressure control chamber 152 contracts. Then, the increase in the negative pressure in the second pressure control chamber 152 increases the flow-in rate of the ink flowing into the second pressure control chamber 152 via the bypass passage 160, and the second pressure control chamber 152 is stabilized in a state where the flow-out rate and the flow-in rate are balanced. As described above, the negative pressure in the second pressure control chamber 152 resultantly increases depending on the duty. Moreover, in the configuration in which the communication port 191B is in the closed state in a case where the circulating pump 500 is driven as described above, the communication port 191B switches to the open state depending on the duty, and the ink flows from the bypass passage 160 into the second pressure control chamber 152.

Then, in a case where the high-duty printing is further continued, the amount of ink flowing from the pressure chamber 12 into the second pressure control chamber 152 via the collection passage 140 decreases, and instead, the amount of ink flowing into the second pressure control chamber 152 via the bypass passage 160 from the communication port 191B increases. In a case where this state further progresses, the amount of ink flowing from the pressure chamber 12 into the second pressure control chamber 152 via the collection passage 140 reaches zero, and all the ink flowing into the circulating pump 500 is supplied from the ink flowing in from the communication port 191B to the second pressure control chamber 152. In a case where this state further progresses, the ink then backflows from the second pressure control chamber 152 to the pressure chamber 12 via the collection passage 140. In this state, the ink flowing out from the second pressure control chamber 152 to the circulating pump 500 and the ink flowing out to the pressure chamber 12 have flowed into the second pressure control chamber 152 via the bypass passage 160 from the communication port 191B. In this case, the pressure chamber 12 is filled with the ink from the supply passage 130 and the ink from the collection passage 140, and these inks are ejected.

Note that this backflow of the ink that occurs in a case where the print duty is high is a phenomenon that occurs due to provision of the bypass passage 160. Moreover, although the example in which the communication port 191B in the second pressure adjustment unit 150 switches to the open state depending on the backflow of the ink is explained above, the backflow of the ink may occur while the communication port 191B in the second pressure adjustment unit 150 is in the open state. Moreover, providing the bypass passage 160 in a configuration in which no second pressure adjustment unit 150 is provided can cause the above-mentioned backflow of the ink to occur also in this configuration. Note that the bypass passage 160 only needs to communicate with the downstream passage and at least one of the upstream passage and the first pressure adjustment unit 120 without communicating therewith via the pressure chamber 12.

### <Configuration of Ejection Unit>

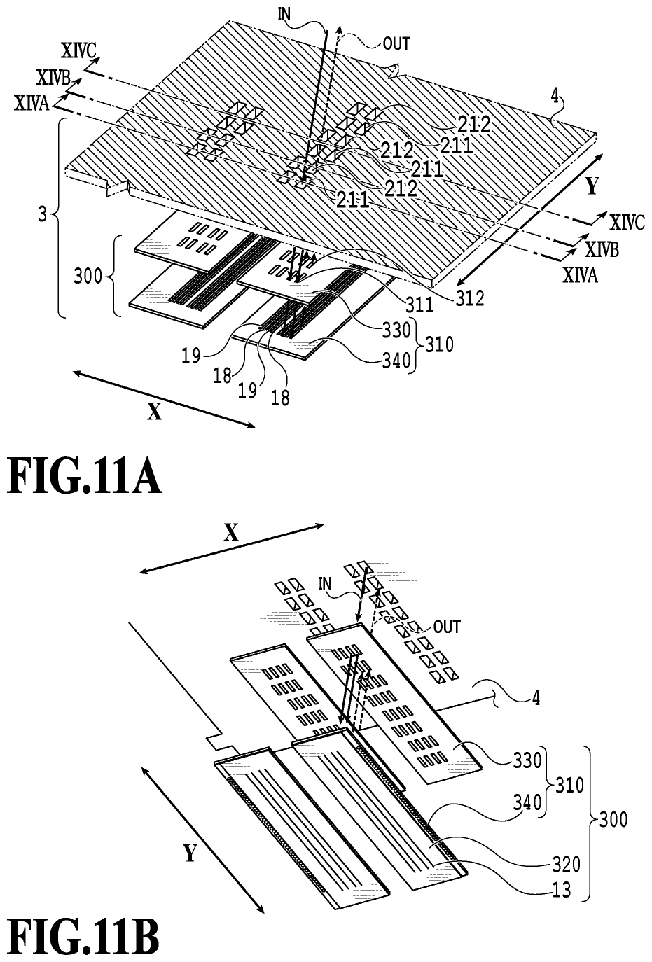

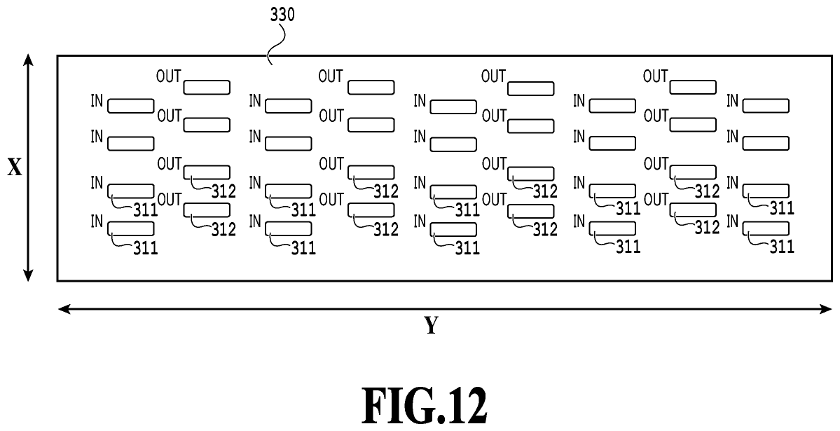

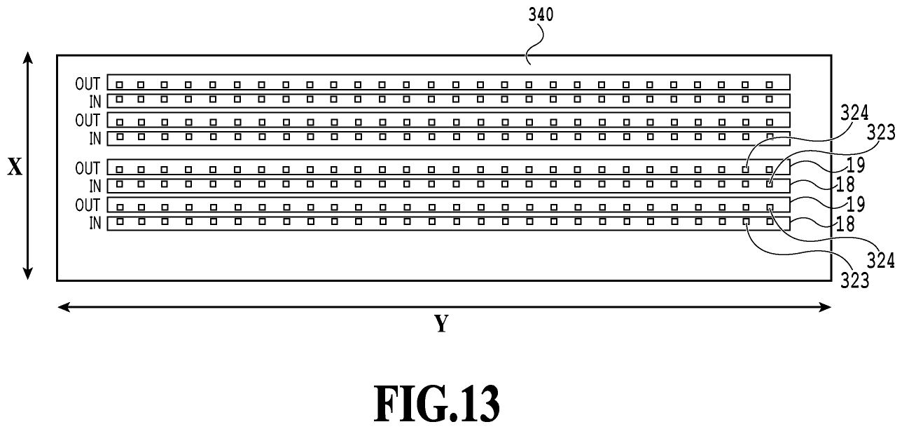

FIGS. 11A and 11B are schematic diagrams illustrating the circulation path for one ink color in the ejection unit 3 of the present embodiment. FIG. 11A is an exploded perspective diagram of the ejection unit 3 as viewed from the first supporting member 4 side, and FIG. 11B is an exploded perspective view of the ejection unit 3 as viewed from the ejection module 300 side. Note that the arrows denoted by IN and OUT in FIGS. 11A and 11B illustrate the flow of the ink. Although the flow of ink for one color is explained, the flows are the same for the other colors. Moreover, illustration of the second supporting member 7 and the electric wiring member 5 is omitted in FIGS. 11A and 11B, and explanation thereof is also omitted in the following explanation of the configuration of the ejection unit. Furthermore, for the first supporting member 4 in FIG. 11A, a cross-section along the XI-XI line in FIG. 3A is illustrated. The ejection module 300 includes an ejection element substrate 340, an opening plate 330, and the ejection port formation member 320. FIG. 12 is a diagram illustrating the opening plate 330, and FIG. 13 is a diagram illustrating the ejection element substrate 340.

The ink is supplied from the circulation unit 54 to the ejection unit 3 via the joint member 8 (see FIGS. 3A and 3B). The path of the ink from the point after the passing of the joint member 8 to the point of returning to the joint member 8 is explained. Note that illustration of the joint member 8 is omitted in the following drawings.

As described above, the ejection module 300 includes the ejection element substrate 340, the opening plate 330, and the ejection port formation member 320. The ejection element substrate 340 and the opening plate are formed of integrated or separate silicon substrates 310. The ejection element substrate 340, the opening plate 330, and the ejection port formation member 320 are laid one on top of another and joined to one another to allow ink passages to communicate with one another, and the ejection module 300 is thereby formed, and is supported on the first supporting member 4. Supporting the ejection module 300 on the first supporting member 4 forms the ejection unit 3. The ejection element substrate 340 includes the ejection port formation member 320, the ejection port formation member 320 has multiple ejection port arrays in which multiple ejection ports 13 form arrays, and part of the ink supplied via the ink passages in the ejection module 300 is ejected from the ejection ports 13. The not-ejected ink is collected via the ink passages in the ejection module 300.

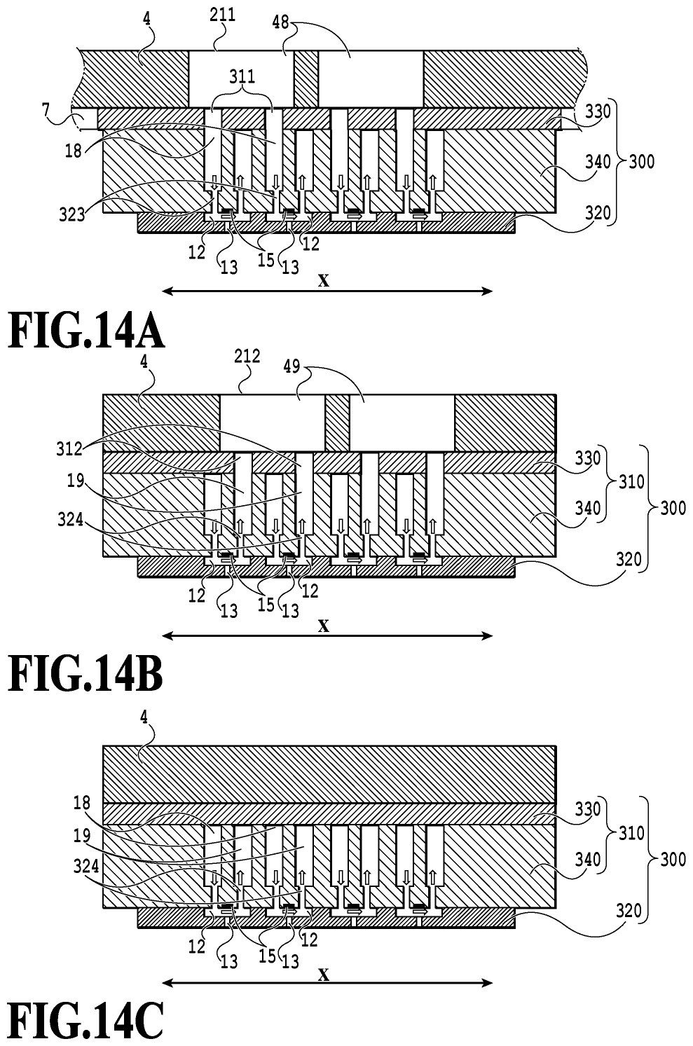

As illustrated in FIGS. 11A, 11B and 12, the opening plate 330 has multiple aligned ink supply ports 311 and multiple aligned ink collection ports 312. As illustrated in FIGS. 13 and FIG. 14A to 14C, the ejection element substrate 340 has the multiple aligned supply connection passages 323 and the multiple aligned collection connection passages 324. The ejection element substrate 340 further has the common supply passages 18 communicating with the multiple supply connection passages 323 and the common collection passages 19 communicating with the multiple collection connection passages 324. The ink passages in the ejection unit 3 are formed by causing the ink supply passage 48 and the ink collection passage 49 (see FIG. 3) provided in the first supporting member 4 to communicate with the passages provided in the ejection module 300. Supporting member supply ports 211 (see FIGS. 11A and 14A) are cross-sectional openings forming the ink supply passage 48, and supporting member collection ports 212 (see FIGS. 11A and 14B) are cross-sectional openings forming the ink collection passage 49.

The ink supplied to the ejection unit 3 is supplied from the circulation unit 54 (see FIG. 3A) side to the ink supply passage 48 (see FIG. 3A) of the first supporting member 4. The ink flowing through the supporting member supply ports 211 in the ink supply passage 48 is supplied to the common supply passages 18 of the ejection element substrate 340 via the ink supply passage 48 (see FIG. 3A) and the ink supply ports 311 of the opening plate 330, and enters the supply connection passages 323. Passages up to this point are a supply side passage. Then, the ink flows through the pressure chambers 12 (see FIG. 3B) of the ejection port formation member 320, and flows to the collection connection passages 324 in a collection side passage. Details of the flow of ink in the pressure chambers 12 are described later.

In the collection side passage, the ink entering the collection connection passages 324 flows to the common collection passages 19. Then, the ink flows from the common collection passages 19 to the ink collection passage 49 of the first supporting member 4 via the ink collection ports 312 of the opening plate 330, flows through the supporting member collection ports 212, and is collected into the circulation unit 54.

A region of the opening plate 330 where there are no ink supply ports 311 or ink collection ports 312 corresponds to a region of the first supporting member 4 that partitions the supporting member supply ports 211 and the supporting member collection ports 212 from one another. Moreover, the first supporting member 4 has no openings in this region. Such a region is used as a bonding region in a case where the ejection modules 300 and the first supporting member 4 are bonded to each other.

In FIG. 12, in the opening plate 330, multiple arrays of multiple openings aligned in the X direction are provided in the Y direction, and openings for supply (IN) and openings for collection (OUT) are alternately aligned in the Y direction while being shifted from one another by a half pitch in the X direction. In FIG. 13, in the ejection element substrate 340, the common supply passages 18 each communicating with the multiple supply connection passages 323 aligned in the Y direction and the common collection passages 19 each communicating with the multiple collection connection passages 324 aligned in the Y direction are alternately aligned in the X direction. The common supply passages 18 and the common collection passages 19 are provided separately for each type of ink, and the number of arranged common supply passages 18 and common collection passages 19 is determined depending on the number of ejection port arrays for each color. Moreover, the number of arranged supply connection passages 323 and collection connection passages 324 corresponds to the ejection ports 13. Note that the supply connection passages 323 and the collection connection passages 324 do not have be in one-to-one correspondence with the ejection ports 13, and one supply connection passage 323 and one collection connection passage 324 may be provided for multiple ejection ports 13.

The opening plate 330 and the ejection element substrate 340 as described above are laid one on top of the other and are joined to each other to allow the ink passages to communicate with one another, and the ejection module 300 is thereby formed. The ejection module 300 is supported on the first supporting member 4, and an ink passage including the supply passage and the collection passage as described above is thereby formed.

FIGS. 14A to 14C are cross-sectional diagrams illustrating ink flows in different portions of the ejection unit 3. FIG. 14A illustrates a cross-section along the XIVa-XIVa line in FIG. 11A, and illustrates a cross section of a portion where the ink supply passage 48 and the ink supply ports 311 communicate with one another in the ejection unit 3. Moreover, FIG. 14B illustrates a cross section along the XIVb-XIVb line in FIG. 11A, and illustrates a cross section of a portion where the ink collection passage 49 and the ink collection ports 312 communicate with one another in the ejection unit 3. Furthermore, FIG. 14C illustrates a cross section along the XIVc-XIVc line in FIG. 11A, and illustrates a cross section of a portion where neither the ink supply ports 311 nor the ink collection ports 312 communicate with the passages of the first supporting member 4.

In the supply passage in which the ink is supplied, as illustrated in FIG. 14A, the ink is supplied from the portion where the ink supply passage 48 of the first supporting member 4 and the ink supply ports 311 of the opening plate 330 overlap and communicate with one another. Moreover, in the collection passage in which the ink is collected, as illustrated in FIG. 14B, the ink is collected from the portion where the ink collection passage 49 of the first supporting member 4 and the ink collection ports 312 of the opening plate 330 overlap and communicate with one another. Furthermore, as illustrated in FIG. 14C, the ejection unit 3 partially includes the region where no openings are provided in the opening plate 330. In such a region, no supply or collection of ink is performed between the ejection element substrate 340 and the first supporting member 4. The supply of ink is performed in the region where the ink supply ports 311 are provided as in FIG. 14A, and the collection of ink is performed in the region where the ink collection ports 312 are provided as in FIG. 14B. Note that, although explanation is given by using the configuration using the opening plate 330 as an example in the present embodiment, a mode using no opening plate 330 may be adopted. For example, the configuration may be such that passages corresponding to the ink supply passage 48 and the ink collection passage 49 are formed in the first supporting member 4, and the ejection element substrate 340 is joined to the first supporting member 4.

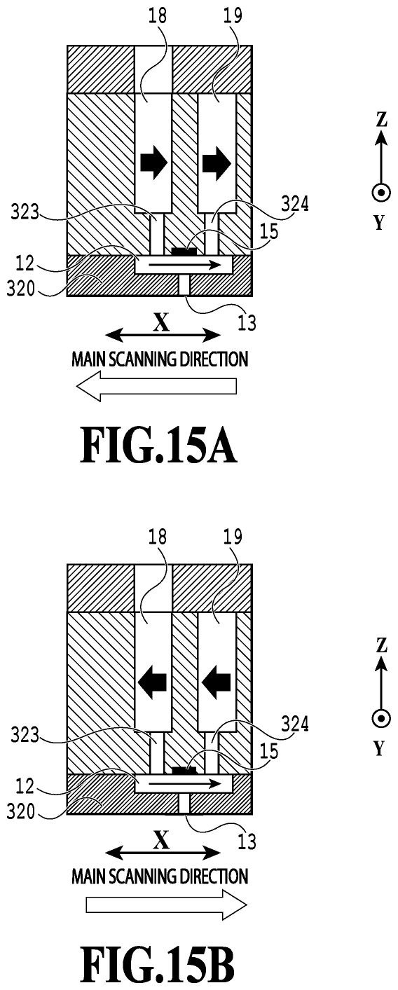

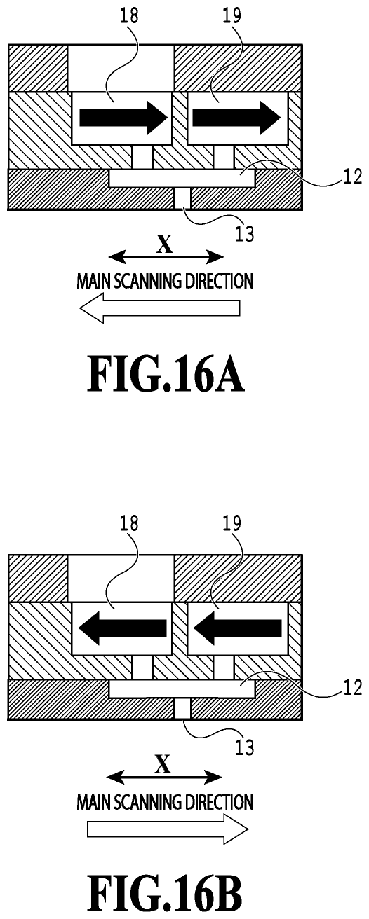

FIGS. 15A and 15B are cross-sectional diagrams illustrating an area near the ejection port 13 in the ejection module 300, and FIGS. 16A and 16B are cross-sectional diagrams illustrating an ejection module with a configuration in which the common supply passage 18 and the common collection passage 19 are extended in the X direction as a comparative example. Note that the bold arrows illustrated in the common supply passage 18 and the common collection passage 19 in FIGS. 15A and 15B and FIGS. 16A and 16B illustrate oscillation of the ink in the mode in which the serial liquid ejection apparatus 50 is used. The ink supplied to the pressure chamber 12 via the common supply passage 18 and the supply connection passage 323 is ejected from the ejection port 13 by drive of the ejection element 15. In a case where the ejection element 15 is not driven, the ink is collected from the pressure chamber 12 into the common collection passage 19 via the collection connection passage 324 that is the collection passage.

In a case where the ink circulated as described above is ejected in the mode in which the serial liquid ejection apparatus 50 is used, the ejection of ink is affected in no small way by the oscillation of ink in the ink passage caused by the main scanning of the liquid ejection head 1. Specifically, the effect of the oscillation of ink in the ink passage sometimes appears as variation in the ink ejection amount or deviation of the ejection direction. In a case where the common supply passage 18 and the common collection passage 19 each have a cross-sectional shape with a large width in the X direction that is the main scanning direction as shown in FIGS. 16A and 16B, the ink in the common supply passage 18 and the common collection passage 19 tends to receive inertia force in the main scanning direction, and large oscillation occurs in the ink. As a result, there is a possibility that the oscillation of ink affects the ejection of ink from the ejection port 13. Moreover, in a case where the common supply passage 18 and the common collection passage 19 are extended in the X direction, a distance between colors is increased, and printing efficiency may decrease.

Accordingly, the common supply passage 18 and the common collection passage 19 in the present embodiment are both configured to extend in the Y direction and also in the Z direction that is perpendicular to the X direction being the main scanning direction on the cross-section illustrated in FIGS. 15A and 15B. Such a configuration can reduce the passage width of each of the common supply passage 18 and the common collection passage 19 in the main scanning direction. Reducing the passage width of each of the common supply passage 18 and the common collection passage 19 in the main scanning direction reduces the oscillation of ink caused by inertia force (black bold arrows in FIGS. 15A and 15B) acting on the ink in the common supply passage 18 and the common collection passage 19 in the opposite direction to the main scanning direction during the main scanning. The effect of the ink oscillation on the ink ejection can be thereby suppressed. Moreover, extending the common supply passage 18 and the common collection passage 19 in the Z direction increases the cross-sectional area and reduces the passage pressure loss.

As described above, although the configuration is such that the oscillation of ink in the common supply passage 18 and the common collection passage 19 in the main scanning is reduced by reducing the passage width of each of the common supply passage 18 and the common collection passage 19 in the main scanning direction, the oscillation is not eliminated. Accordingly, in order to suppress variation in ejection among the ink types that occurs even in a case where the oscillation is reduced, in the present embodiment, the common supply passage 18 and the common collection passage 19 are arranged at overlapping positions in the X direction.

As described above, in the present embodiment, the supply connection passage 323 and the collection connection passage 324 are provided to correspond to the ejection port 13, and the supply connection passage 323 and the collection connection passage 324 are in such a correspondence relationship that they are arranged side by side in the X direction with the ejection port 13 between them. Accordingly, if there is a portion where the common supply passage 18 and the common collection passage 19 do not overlap each other in the X direction and the correspondence relationship between the supply connection passage 323 and the collection connection passage 324 in the X direction collapses, the ejection and the flow of ink in the X direction in the pressure chamber 12 are affected. Addition of the effect of the ink oscillation to the effect of the collapse of correspondence relationship may further affect the ink ejection in each ejection port.

Accordingly, the common supply passage 18 and the common collection passage 19 are arranged at overlapping positions in the X direction so that, when main scanning is performed, the ink oscillation in the common supply passage 18 and the ink oscillation in the common collection passage 19 are substantially equal to each other at any position in the Y direction in which the ejection ports 13 are arranged. As a result, there is no large variation in a pressure difference generated in the pressure chamber 12 between the common supply passage 18 side and the common collection passage 19 side, and stable ejection can be performed.

Moreover, although there is a liquid ejection head in which the passage for supplying the ink to the liquid ejection head and the passage for collecting the ink are formed of the same passage among the liquid ejection heads in which the ink is circulated, in the present embodiment, the common supply passage 18 and the common collection passage 19 are separate passages. Moreover, the supply connection passage 323 and the pressure chamber 12 communicate with each other, the pressure chamber 12 and the collection connection passage 324 communicate with each other, and the ink is ejected from the ejection port 13 of the pressure chamber 12. In other words, the pressure chamber 12 that is a path connecting the supply connection passage 323 and the collection connection passage 324 is configured to include to the ejection port 13. Accordingly, the ink flow flowing from the supply connection passage 323 side to the collection connection passage 324 side is generated in the pressure chamber 12, and the ink in the pressure chamber 12 is efficiently circulated. Efficient circulation of the ink in the pressure chamber 12 can maintain the ink in the pressure chamber 12, that tends to be affected by evaporation of the ink from the ejection port 13, in a fresh state.

Furthermore, the two passages of the common supply passage 18 and the common collection passage 19 communicate with the pressure chamber 12, and this allows the ink to be supplied from both passages in a case where the ejection needs to be performed at a high flow rate. Specifically, the configuration in the present embodiment has the following advantages over a configuration in which the supply and collection of the ink are performed with one passage. Specifically, the configuration in the present embodiment has such advantages that the present embodiment can perform circulation more efficiently and can handle ejection of a high flow rate, over a configuration in which the supply and collection of the ink are performed with one passage.

Moreover, the effect of the ink oscillation is less likely to occur in a case where the common supply passage 18 and the common collection passage 19 are arranged at close positions in the X direction. The distance between the passages is desirably configured to be 75 μm to 100 μm.

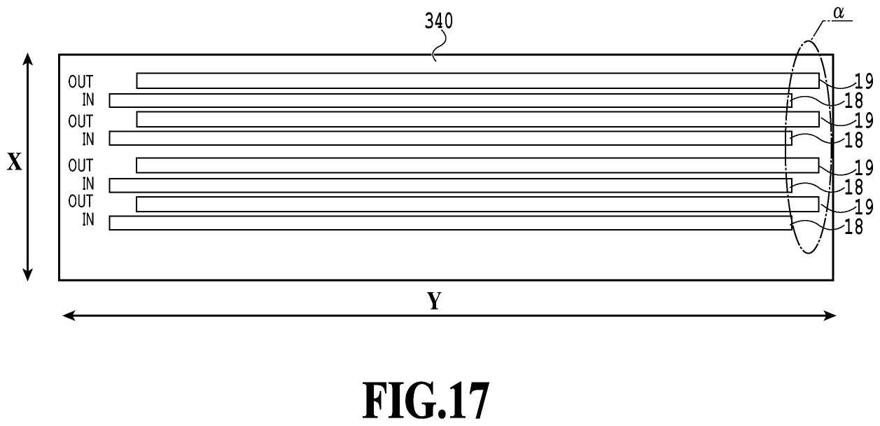

FIG. 17 is a diagram illustrating the ejection element substrate 340 as a comparative example. In FIG. 17, illustration of the supply connection passages 323 and the collection connection passages 324 is omitted. Since the ink that has received thermal energy generated by the ejection elements 15 in the pressure chambers 12 flows into the common collection passages 19, the ink with higher temperature than temperature of the ink in the common supply passages 18 flows in the common collection passages 19. As illustrated in the a portion surrounded by the dash-dot line in FIG. 17, this comparative example has a portion in which only the common collection passages 19 are present, in one portion of the ejection element substrate 340 in the X direction. In this case, the temperature locally increases in this portion, and temperature unevenness occurs in the ejection module 300. This may affect the ejection.

The ink with lower temperature than that in the common collection passages 19 flows in the common supply passages 18. Accordingly, in a case where the common supply passages 18 and the common collection passages 19 are adjacent to one another, the temperature of the common supply passages 18 and the temperature of the common collection passages 19 are partially cancelled out near these passages, and an increase in temperature is thereby suppressed. Accordingly, it is preferable that the common supply passages 18 and the common collection passages 19 have substantially the same length, are present at overlapping positions in the X direction, and are adjacent to one another.

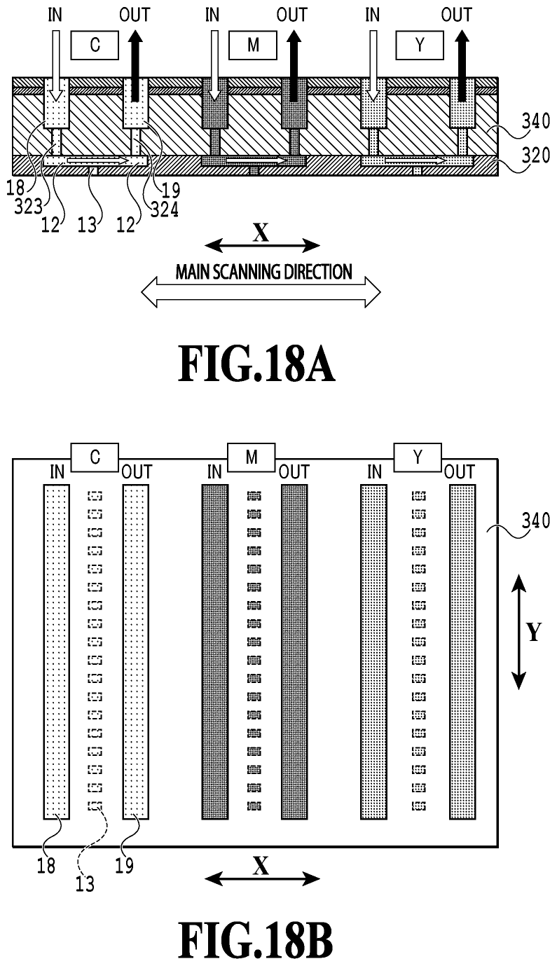

FIGS. 18A and 18B are diagrams illustrating passages configurations of the liquid ejection head 1 for the inks of three colors of cyan (C), magenta (M), and yellow (Y). As illustrated in FIG. 18A, the liquid ejection head 1 is provided with circulation passages for the respective types of inks. The pressure chambers 12 are provided along the X direction that is the main scanning direction of the liquid ejection head 1. Moreover, as illustrated in FIG. 18B, for each type of ink, the common supply passage 18 and the common collection passage 19 are provided along the ejection port array in which the ejection ports 13 are aligned, and are provided to extend in the Y direction with the ejection port array arranged between the common supply passage 18 and the common collection passage 19.

### <Connection Between Main Body Portion and Liquid Ejection Head>

FIG. 19 is a schematic configuration diagram illustrating a connection state of the liquid ejection head 1 with the ink tanks 2 and the external pumps 21 provided in a main body portion of the liquid ejection apparatus 50 in the present embodiment and arrangement of the circulating pump and the like in further detail. The liquid ejection apparatus 50 in the present embodiment has such a configuration that, in a case where a trouble occurs in the liquid ejection head 1, the liquid ejection head 1 alone can be easily replaced. Specifically, the liquid ejection apparatus 50 includes a liquid connection portion 700 that allows connection and separation of the liquid ejection head 1 and the ink supply tubes 59 connected to the external pumps 21 to be easily performed. The liquid ejection head 1 alone can be thereby easily attached to and detached from the liquid ejection apparatus 50.

As illustrated in FIG. 19, the liquid connection portion 700 includes the liquid connector insertion ports 53a that are provided in the head case 53 of the liquid ejection head 1 to protrude and cylindrical liquid connectors 59a to which the liquid connector insertion ports 53a can be inserted. The liquid connector insertion ports 53a are fluidly connected to the ink supply passages formed in the liquid ejection head 1, and are connected to the first pressure adjustment units 120 via the above-mentioned filters 110. Moreover, the liquid connectors 59a are provided at the front ends of the ink supply tubes 59 connected to the external pumps 21 that pressurize and supply the inks in the ink tanks 2 to the liquid ejection head 1.

As described above, in the liquid ejection head 1 illustrated in FIG. 19, the liquid connection portion 700 allows work of detaching, attaching, and replacing the liquid ejection head 1 to be easily performed. However, in a case where a sealing property of the liquid connector insertion ports 53a and the liquid connectors 59a decreases, there is a possibility that the inks pressurized and supplied by the external pumps 21 leak from the liquid connection portion 700. In a case where the leaked inks attach to the circulating pumps 500 or the like, a trouble may occur in an electric system. Accordingly, in the present embodiment, the circulating pumps and the like are arranged as follows.

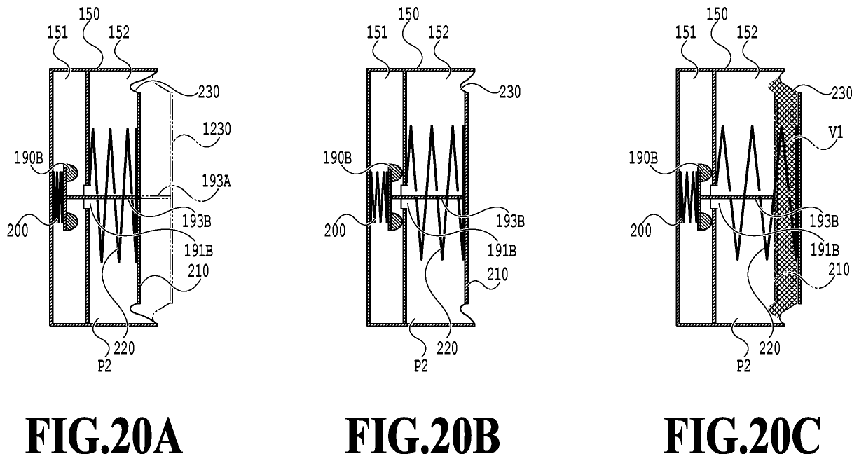

FIG. 19 and FIGS. 20A to 20C are diagrams explaining characteristic portions of the present embodiment.

FIG. 20A illustrates a schematic cross-sectional diagram of the second pressure adjustment unit 150 in a period in which the ink is circulated by the operation of the circulating pump 500 (that is circulation period). Note that the broken lines 1230 in FIG. 20A illustrate the pressure plate 210, the flexible member 230, and the shaft 193A of the first pressure adjustment unit 120 in this period.

As illustrated in FIG. 20A, the length of the shaft 193A of the first pressure control chamber 122 and the length of the shaft 193B of the second pressure control chamber 152 are determined such that the shaft 193B is shorter than the shaft 193A. This causes the pressure plate 210 of the first pressure control chamber 122 to be arranged at the position illustrated by the broken lines 1230 and the pressure plate 210 of the second pressure control chamber 152 to be arranged at the position illustrated by the solid line in the print operation period. Accordingly, in the print operation period, the pressure in the second pressure control chamber 152 is lower than the pressure in the first pressure control chamber 122.

Note that the configuration that causes the pressure in the second pressure control chamber 152 to be lower than the pressure in the first pressure control chamber 122 is not limited to the above configuration.

The pressure in the second pressure control chamber 152 can be made lower than the pressure in the first pressure control chamber 122 by changing other parts forming the second pressure control chamber 152, though this configuration is not described in detail because it is not an essential part of the present disclosure. Moreover, the pressure in the second pressure control chamber 152 can be made lower than the pressure in the first pressure control chamber 122 by adjusting a positional relationship of the first pressure control chamber 122 and the second pressure control chamber 152 in the direction of gravity.

The arrows X to Z in FIG. 19 illustrate three passages that allow the first pressure control chamber 122 and the second pressure control chamber 152 to communicate with each other and directions of flows after stop of the circulating pump 500.

As illustrated in FIG. 19, the passages that allow the first pressure control chamber 122 and the second pressure control chamber 152 to communicate with each other include a passage X that passes through the circulating pump 500, a passage Y that passes through the ejection module 300, and a passage Z that passes through none of the above units. In this case, the passage X includes the pump exit passage 180, the circulating pump 500, and the pump entrance passage 170. The passage Y includes the supply passage 130, the pressure chamber 12, and the collection passage 140. The passage Z includes the bypass passage 160.

As explained with reference to FIGS. 10A to 10E, in a case where the operating circulating pump 500 is stopped, fluid in the first pressure control chamber 122 moves to the second pressure control chamber 152 until the pressure in the first pressure control chamber 122 and the pressure in the second pressure control chamber 152 become equal to each other. The fluid described herein includes the ink and air as described later. Normally, the fluid moves by mainly passing through the passage Y and the passage Z. Since the passage X includes the circulating pump 500 and the circulating pump 500 includes the check valves therein, the fluid normally hardly flows through the passage X.

However, although the check valves 504a and 504b of the circulating pump 500 are located at an intermediate portion between the pump supply hole 501 and the pump chamber 503 and an intermediate portion between the pump discharge hole 502 and the pump chamber 503, the check valves 504a and 504b are not biased toward the wall surfaces to which the check valves 504a and 504b come into tight contact.

This is due to the following reason. In a case where a configuration in which the check valves 504a and 504b are normally closed by being biased by springs or the like is adopted, extra force for cancelling biasing force is necessary, and a pump performance needs to be improved by a degree corresponding to the extra force. This leads to increases in size and cost.

Accordingly, in a case where the circulating pump 500 is stopped, the fluid slightly leaks from each of the check valves 504a and 504b that are not biased. The fluid may thus flow from the first pressure control chamber 122 to the second pressure control chamber 152 via the passage X depending on the size of valve chambers and the states of the check valves.

Accordingly, in a case where the flow resistance of the passage Y greatly increases for some reason (for example, bubbles or the like) at stop of the circulating pump 500 and exceeds the flow resistance of the passage X, the fluid supposed to flow from the first pressure control chamber 122 to the passage Y may flow to the passage X.

In this case, no problem occurs if the fluid flowing out from the first pressure control chamber 122 to the passage X is liquid. However, in a configuration in which the first pressure control chamber 122 does not have the ink outlet to the ejection module 300 in the upper portion of the first pressure control chamber 122 as in the present example, air that has stayed from initial filling of the ink or air that has flowed in from upstream may be accumulated in the upper portion of the first pressure control chamber 122.

Specifically, in a case where the pump outlet 180a is provided in the upper portion of the first pressure control chamber 122 as a measure against precipitation as in the present example, the fluid flowing out from the first pressure control chamber 122 to the passage X may be air.

As described above, the circulating pump 500 of the present example is a small piezoelectric diaphragm pump, and in a case where air flows into the circulating pump 500, the pump performance may decrease due to a damping effect of air or the like. Accordingly, flowing of air into the circulating pump 500 needs to be prevented.

To this end, the volume V2 of the pump exit passage 180 needs to satisfy the following relationship with the volume VV.

VV<V2

In this case,

Volume VV: the volume of fluid passing the pump outlet 180a in a direction from the first pressure control chamber toward the pump exit passage 180 in a period from a time when operation of the circulating pump 500 is stopped to a time when pressure in the first pressure control chamber 122 and pressure in the second pressure control chamber 152 become equal to each other.

Moreover, the pump outlet 180a is a communication port of the first pressure control chamber 122 and the pump exit passage 180.

However, the volume VV generally varies. Accordingly, a volume VT that is the maximum estimated value of the volume VV may be used instead of the volume VV. In this case, the volume VT is a volume of the fluid flowing from the first pressure control chamber 122 into the second pressure control chamber 152 in a period from a time when operation of the circulating pump 500 is stopped to a time when pressure in the first pressure control chamber 122 and pressure in the second pressure control chamber 152 become equal to each other. Specifically, the condition of

VV<V2

may be changed to

VT<V2.

Note that, since the relationship of

VV≤VT

is satisfied, in a case where the relationship of

VT<V2

is satisfied, the above-mentioned relationship of

VV<V2

is also satisfied.

The volume VT can be calculated in advance based on pressure characteristics of the second pressure adjustment unit 150 and the set pressure of the first pressure control chamber 122.

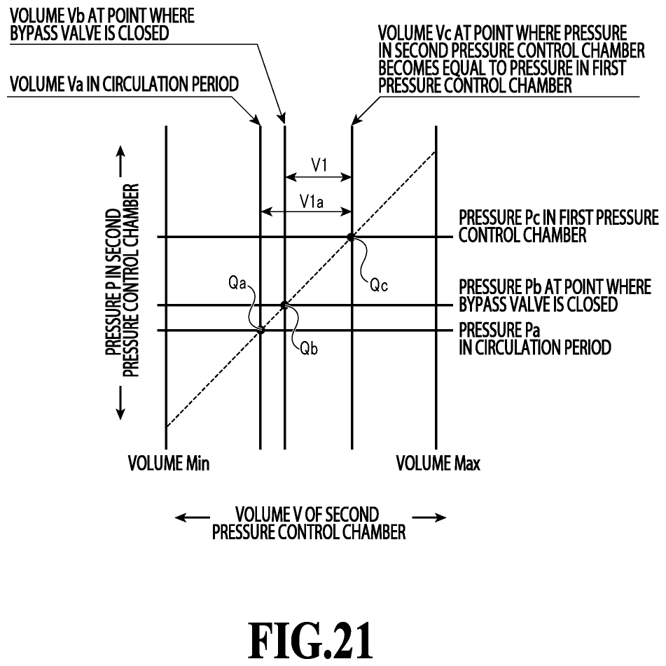

FIGS. 20A to 20C illustrate state transition of the second pressure control chamber 152 after stop of the circulating pump. Moreover, FIG. 21 illustrates a graph of a volume-to-pressure characteristic of the second pressure control chamber 152. The point Qa (Va, Pa) in the graph of FIG. 21 corresponds to FIG. 20A, the point Qb (Vb, Pb) in the graph of FIG. 21 corresponds to FIG. 20B, and the point Qc (Vc, Pc) in the graph of FIG. 21 corresponds to FIG. 20C.

The solid lines in FIG. 20A illustrate the shape of the second pressure adjustment unit 150 in the circulation period.

The broken lines 1230 in FIG. 20A illustrate the pressure plate 210, the shaft 193A, and the flexible member 230 of the first pressure adjustment unit 120 in the circulation period as described above. In this case, if the pressure in the first pressure control chamber 122 is always constant, the pressure plate 210 and the flexible member 230 of the first pressure adjustment unit 120 are arranged at the positions illustrated by the broken lines 1230 when the pressure in the first pressure control chamber 122 and the pressure in the second pressure control chamber 152 become equal to each other.

FIG. 20B illustrates the shape of the second pressure adjustment unit 150 when the valve 190B closes the communication port 191B in the second pressure adjustment unit 150. Moreover, FIG. 20C illustrates the shape of the second pressure adjustment unit 150 when the pressure in the first pressure control chamber 122 and the pressure in the second pressure control chamber 152 become equal to each other.

In the graph of FIG. 21, in the circulation period, the volume and pressure of the second pressure control chamber 152 are at the position of the point Qa (Va, Pa). The pressure Pa is lower than the pressure Pc in the first pressure control chamber 122.

Moreover, when the pressure in the second pressure control chamber 152 becomes equal to the pressure in the first pressure control chamber 122, the volume and pressure of the second pressure control chamber 152 are at the position of the point Qc (Vc, Pc).

Accordingly, in a configuration with no passage Z (bypass passage 160), a difference obtained by subtracting the volume Va from the volume Vc is a flow-in volume V1a of the fluid flowing from the first pressure control chamber 122 into the second pressure control chamber 152 via the passage X or the passage Y (V1a=Vc−Va).

Particularly, in a case where the passage Y is closed in this configuration, the difference obtained by subtracting the volume Va from the volume Vc is the flow-in volume V1a of the fluid flowing from the first pressure control chamber 122 into the second pressure control chamber 152 via the passage X (V1a=Vc−Va). Moreover, in a case where the flow resistance of the passage Y is far greater than the flow resistance of the passage X, this difference is substantially equal to the flow-in volume V1a of the fluid flowing from the first pressure control chamber 122 into the second pressure control chamber 152 via the passage X (V1a≈Vc−Va).

Accordingly, setting the volume V2 of the pump exit passage 180 such that

$$Vc - Va < V 2$$

is satisfied can avoid air present in the first pressure control chamber 122 from reaching the circulating pump 500 via the pump exit passage 180 also in a configuration in which both of the passage Y and the passage Z (bypass passage 160) are absent. Specifically, air present in the first pressure control chamber 122 can be avoided from reaching the circulating pump 500 via the pump exit passage 180 also in a configuration in which both of the passage Y and the passage Z (bypass passage 160) are absent just after the stop of the circulating pump 500.

Note that setting the volume V2 of the pump exit passage 180 such that

$$Vc - Va < V 2$$

is satisfied can avoid air present in the first pressure control chamber 122 from reaching the circulating pump 500 via the pump exit passage 180 in a configuration in which the passage Y is present in addition to the passage X, in a configuration in which the passage Z is present in addition to the passage X, and in a configuration in which the passages Y and Z are present in addition to the passage X as well as in a configuration in which the passages Y and Z are not present, as a matter of course.

There is a configuration in which the valve 190 does not close the communication port 191B in the second pressure adjustment unit 150 as illustrated in FIG. 20A not only in the period in which the ink is ejected from the ejection port 13 by a predetermined amount or more but also averagely in the circulation period. In such a configuration, the passage Z (bypass passage 160) is closed (disappears) after certain time elapses from the stop of the circulating pump 500. In a period from a time when the passage Z is changed to be closed to a time when pressure in the first pressure control chamber 122 and pressure in the second pressure control chamber 152 become equal to each other, the liquid flows from the first pressure control chamber 122 into the second pressure control chamber 152 via the passage X or the passage Y. Accordingly, a lower limit value of the volume V2 is defined assuming that the liquid flows from the first pressure control chamber 122 into the second pressure control chamber 152 only via the passage X in the period from a time when the passage Z is changed to be closed to a time when pressure in the first pressure control chamber 122 and pressure in the second pressure control chamber 152 become equal to each other. This can avoid air present in the first pressure control chamber 122 from reaching the circulating pump 500 via the pump exit passage 180. Note that, in this example, it is assumed that fluid flowing into the passage X in a period from a time when operation of the circulating pump 500 is stopped to a time when the passage Z is changed to be closed be ignored.

Since the fluid flows from the first pressure control chamber 122 into the second pressure control chamber 152 after the stop of the circulating pump 500, the valve 190B closes the communication port 191B in the second pressure adjustment unit 150 after certain time elapses from the stop of the circulating pump 500. The passage Z (bypass passage 160) is closed at this moment. Note that the pressure plate 210 abuts the valve shaft 193B at this moment. In the graph of FIG. 21, the volume and pressure of the second pressure control chamber 152 at this moment are at the position of the point Qb (Vb, Pb). Then, further flowing of fluid into the second pressure control chamber 152 causes the second pressure adjustment unit 150 to have the shape as illustrated in FIG. 20C. In this shape, the communication port 191B is kept closed by the valve 190B, and the pressure plate 210 is separated from the valve shaft 193B. At this moment, the volume and pressure of the second pressure control chamber 152 are at the position of the point Qc (Vc, Pc).

In a section from the point Qb to the point Qc, the bypass passage 160 that is the passage Z is absent. Accordingly, a difference obtained by subtracting the volume Vb from the volume Vc is the flow volume V1 of fluid flowing from the first pressure control chamber 122 into the second pressure control chamber 152 via the passage X or the passage Y (V1=Vc−Vb).

Particularly, in the configuration in which not only the passage Z but also the passage Y is absent, the difference obtained by subtracting the volume Vb from the volume Vc is the flow volume V1 of fluid flowing from the first pressure control chamber 122 into the second pressure control chamber 152 via the passage X (V1=Vc−Vb).

Accordingly, setting the volume V2 of the pump exit passage 180 such that

$$Vc - Vb < V 2$$

is satisfied can avoid air present in the first pressure control chamber 122 from reaching the circulating pump 500 via the pump exit passage 180 in any of the following configurations. Specifically, air present in the first pressure control chamber 122 can be avoided from reaching the circulating pump 500 via the pump exit passage 180 also in a configuration in which the passage Y is absent and the passage Z becomes absent from an intermediate time point. Moreover, air present in the first pressure control chamber 122 can be avoided from reaching the circulating pump 500 via the pump exit passage 180 also in a configuration in which the passage Y or the passage Z is absent just after stop of the circulating pump 500.

Note that setting the volume V2 of the pump exit passage 180 such that

$$Vc - Vb < V 2$$

is satisfied can avoid air present in the first pressure control chamber 122 from reaching the circulating pump 500 via the pump exit passage 180 also in a configuration in which the passage Y is present and the passage Z becomes absent from an intermediate time point.

Moreover, setting the volume V2 of the pump exit passage 180 such that

$$Vc - Vb < V 2$$

is satisfied can avoid air present in the first pressure control chamber 122 from reaching the circulating pump 500 via the pump exit passage 180 also in a configuration in which the Y passage is present and the passage Z is absent all the time just after stop of the circulating pump 500 (for example, a configuration in which the bypass passage 160 being the passage is not provided). However, in such a configuration, Qa=Qb and thus Va=Vb. Accordingly, the above condition is the same as

$$Vc - Va < V 2$$

### Moreover, if

$$Vc - Vb < V 2$$

is satisfied,

$$Vc - Va < V 2$$

is satisfied. Accordingly,

$$Vc - Va < V 2$$

may be set as the condition also in the configuration in which the passage Z is present.

The following explanation is given with reference to FIG. 21, though this explanation partially overlaps the above explanation. In the period from a time when operation of the circulating pump 500 is stopped to a time when pressure in the first pressure control chamber 122 and pressure in the second pressure control chamber 152 become equal to each other, the volume V1a of fluid flowing from the first pressure control chamber 122 into the second pressure control chamber 152 is

$$V 1 a = Vc - Va .$$

In this period, fluid flows through one to three passages selected from the passage X, the passage Y, and the passage Z.

Accordingly, air in the first pressure control chamber 122 can be avoided from reaching the circulating pump 500 as long as the condition of

$$V 1 a = V c - V a < V 2$$

is satisfied, regardless of which one to three of the passage X, the passage Y, and the passage Z the fluid flows through.

Accordingly, air in the first pressure control chamber 122 can be avoided from reaching the circulating pump 500 in both of the configuration in which the bypass passage 160 being the passage Z is provided and the configuration in which no bypass passage 160 is provided, as long as the condition of

$$V 1 a = V c - V a < V 2$$

is satisfied.

Moreover, as illustrated in FIG. 21, the volume V1 of fluid flowing from the first pressure control chamber 122 into the second pressure control chamber 152 in the period from a time when operation of the circulating pump 500 is stopped to a time when pressure in the first pressure control chamber 122 and pressure in the second pressure control chamber 152 become equal to each other is

$$V 1 = Vc - V b .$$

In this period, the fluid flows through one or two passages selected from the passage X and the passage Y.

Accordingly, air present in the first pressure control chamber 122 can be avoided from reaching the circulating pump 500 regardless of which one or two of the X passage and the Y passage the fluid flows through, as long as the condition of

$$V 1 = Vc - V b < V 2$$

is satisfied.

Similarly, as illustrated in FIG. 21, the configuration in which the bypass passage 160 being the passage Z is absent is as follows. The volume V1 of fluid flowing from the first pressure control chamber 122 into the second pressure control chamber 152 in the period from a time when operation of the circulating pump 500 is stopped to a time when pressure in the first pressure control chamber 122 and pressure in the second pressure control chamber 152 become equal to each other is

$$V 1 = Vc - V b .$$

In this period, the fluid flows through one or two passages selected from the passage X and the passage Y. Note that, in the configuration in which the bypass passage 160 being the passage Z is absent, Va=Vb.

Accordingly, air present in the first pressure control chamber 122 can be avoided from reaching the circulating pump 500 regardless of which one or two of the passage X and the passage Y the fluid flows through, as long as the condition of

$$V 1 = Vc - V b < V 2$$

is satisfied.

In a case where the volume V2 of the pump exit passage 180 is desired to be reduced as much as possible for size reduction, a condition of

$$Vc - Vb < V 2$$

may be selected instead of the condition of

$$Vc - Va < V 2 .$$

Specifically, the lower limit of the allowable range of the volume V2 of the pump exit passage 180 can be reduced.

In this case, it is desirable to adopt a configuration in which an entrance 260 of the bypass passage 160 is provided in a lower-most portion of the first pressure control chamber 122 as illustrated in FIG. 19 to prevent bubbles from blocking the bypass passage 160.

This can prevent air from reaching the circulating pump 500 even in a case where the flow resistance of the passage Y increases by any chance and air accumulated in the upper portion of the first pressure control chamber 122 flows out to the passage X. Accordingly, an operation failure of the circulating pump due to air does not occur, and ejection stability can be improved.

### Other Embodiments

In the above embodiment, when the pressure in the second pressure control chamber 152 becomes equal to the pressure in the first pressure control chamber 122 after the stop of the circulating pump 500, the communication port 191B is kept closed by the valve 190B as illustrated in FIG. 20C. Moreover, the pressure plate 210 is separated from the valve shaft 193B. However, there is a configuration in which the communication port 191B is kept closed by the valve 190B and the pressure plate 210 is abuts the valve shaft 193B at this time point. Also in such a configuration, Vc and Pc at the point Qc can be used as they are as the volume and pressure of the second pressure control chamber 152 when the pressure in the second pressure control chamber 152 becomes equal to the pressure in the first pressure control chamber 122.

Although the circulating pump 500 is installed in the circulation unit 54 as illustrated in FIG. 4 in the above embodiment, the configuration is not limited to this, and the circulating pump 500 may be installed outside the circulation unit 54.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-094246, filed on Jun. 7, 2023, which is hereby incorporated by reference wherein in its entirety.

What is claimed is:

1. A circulation unit comprising:
a first pressure adjustment unit configured to adjust pressure of liquid, the first pressure adjustment unit including a first valve chamber, a first pressure control chamber, a first communication port that allows the first valve chamber and the first pressure control chamber to communicate with each other, a first valve that opens and closes the first communication port, a first flexible member that forms a surface of a portion of the first pressure control chamber and that is configured to be displaceable, and a first pressure plate that forms a surface of another portion of the first pressure control chamber and that is configured to be displaceable by moving together with the first flexible member;
a second pressure adjustment unit configured to adjust pressure of the liquid, the second pressure adjustment unit including a second valve chamber, a second pressure control chamber, a second communication port that allows the second valve chamber and the second pressure control chamber to communicate with each other, a second valve that opens and closes the second communication port, a second flexible member that forms a surface of a portion of the second pressure control chamber and that is configured to be displaceable, and a second pressure plate that forms a surface of another portion of the second pressure control chamber and that is configured to be displaceable by moving together with the second flexible member;
a first passage configured to allow a pressure chamber and the first pressure control chamber to communicate with each other;
a second passage configured to allow the pressure chamber and the second pressure control chamber to communicate with each other;
a third passage configured to allow the second pressure control chamber and a circulating pump to communicate with each other, the circulating pump used to circulate the liquid; and
a fourth passage configured to allow the circulating pump and the first pressure control chamber to communicate with each other, wherein
VV<V2 is satisfied
where VV is a volume of fluid passing a communication port of the first pressure control chamber and the fourth passage in a direction from the first pressure control chamber toward the fourth passage in a period from a time when operation of the circulating pump is stopped to a time when pressure in the first pressure control chamber and pressure in the second pressure control chamber become equal to each other, and V2 is a volume of the fourth passage.

2. The circulation unit according to claim 1, wherein
VT<V2 is satisfied
where VT is a volume of fluid flowing from the first pressure control chamber into the second pressure control chamber in the period from the time when operation of the circulating pump is stopped to the time when pressure in the first pressure control chamber and pressure in the second pressure control chamber become equal to each other, and V2 is a volume of the fourth passage.

3. The circulation unit according to claim 1, wherein
Vc−Va<V2 is satisfied
where Va is a volume of the second pressure control chamber in a period in which the circulating pump is operating, and Vc is a volume of the second pressure control chamber when the pressure in the first pressure control chamber and the pressure in the second pressure control chamber become equal to each other after the time when operation of the circulating pump is stopped.

4. The circulation unit according to claim 1, further comprising a bypass passage configured to allow the first pressure control chamber and the second valve chamber to communicate with each other, wherein
the bypass passage is opened and closed depending on opening and closing of the second communication port by the second valve.

5. The circulation unit according to claim 4, wherein
VT<V2 is satisfied
where VT is a volume of fluid flowing from the first pressure control chamber into the second pressure control chamber in the period from the time when operation of the circulating pump is stopped to the time when pressure in the first pressure control chamber and pressure in the second pressure control chamber become equal to each other, and V2 is a volume of the fourth passage.

6. The circulation unit according to claim 4, wherein
Vc−Va<V2 is satisfied
where Va is a volume of the second pressure control chamber in a period in which the circulating pump is operating, and Vc is a volume of the second pressure control chamber when the pressure in the first pressure control chamber and the pressure in the second pressure control chamber become equal to each other after the time when operation of the circulating pump is stopped.

7. The circulation unit according to claim 4, wherein
Vc−Vb<V2 is satisfied
where Vb is a volume of the second pressure control chamber when the bypass passage is closed after the time when operation of the circulating pump is stopped, and Vc is a volume of the second pressure control chamber when the pressure in the first pressure control chamber and the pressure in the second pressure control chamber become equal to each other after the time when operation of the circulating pump is stopped.

8. The circulation unit according to claim 4, wherein the bypass passage communicates with the first pressure control chamber in a lower-most portion of the first pressure control chamber.

9. The circulation unit according to claim 1, wherein the third passage communicates with the second pressure control chamber in a lower portion of the second pressure control chamber.

10. The circulation unit according to claim 1, wherein the fourth passage communicates with the first pressure control chamber in an upper portion of the first pressure control chamber.

11. A liquid ejection head comprising:
a circulation unit;
the circulating pump; and
an ejection module,
wherein the circulation unit includes
a first pressure adjustment unit configured to adjust pressure of liquid, the first pressure adjustment unit including a first valve chamber, a first pressure control chamber, a first communication port that allows the first valve chamber and the first pressure control chamber to communicate with each other, a first valve that opens and closes the first communication port, a first flexible member that forms a surface of a portion of the first pressure control chamber and that is configured to be displaceable, and a first pressure plate that forms a surface of another portion of the first pressure control chamber and that is configured to be displaceable by moving together with the first flexible member;
a second pressure adjustment unit configured to adjust pressure of the liquid, the second pressure adjustment unit including a second valve chamber, a second pressure control chamber, a second communication port that allows the second valve chamber and the second pressure control chamber to communicate with each other, a second valve that opens and closes the second communication port, a second flexible member that forms a surface of a portion of the second pressure control chamber and that is configured to be displaceable, and a second pressure plate that forms a surface of another portion of the second pressure control chamber and that is configured to be displaceable by moving together with the second flexible member;
a first passage configured to allow a pressure chamber and the first pressure control chamber to communicate with each other;
a second passage configured to allow the pressure chamber and the second pressure control chamber to communicate with each other;
a third passage configured to allow the second pressure control chamber and a circulating pump to communicate with each other, the circulating pump used to circulate the liquid; and
a fourth passage configured to allow the circulating pump and the first pressure control chamber to communicate with each other, wherein
VV<V2 is satisfied
where VV is a volume of fluid passing a communication port of the first pressure control chamber and the fourth passage in a direction from the first pressure control chamber toward the fourth passage in a period from a time when operation of the circulating pump is stopped to a time when pressure in the first pressure control chamber and pressure in the second pressure control chamber become equal to each other, and V2 is a volume of the fourth passage, and
wherein the ejection module includes
an ejection port used to eject the liquid,
the pressure chamber communicating with the ejection port, and
an ejection element configured to cause the liquid to be ejected from the ejection port, via the pressure chamber.

12. The liquid ejection head according to claim 11, wherein the circulating pump is installed inside the circulation unit.

13. A liquid ejection apparatus comprising:
a liquid ejection head,
a carriage configured to perform scanning of the liquid ejection head in a main scanning direction; and
a conveyance unit configured to convey a print medium in a sub scanning direction,
wherein the circulation unit includes
a first pressure adjustment unit configured to adjust pressure of liquid, the first pressure adjustment unit including a first valve chamber, a first pressure control chamber, a first communication port that allows the first valve chamber and the first pressure control chamber to communicate with each other, a first valve that opens and closes the first communication port, a first flexible member that forms a surface of a portion of the first pressure control chamber and that is configured to be displaceable, and a first pressure plate that forms a surface of another portion of the first pressure control chamber and that is configured to be displaceable by moving together with the first flexible member;
a second pressure adjustment unit configured to adjust pressure of the liquid, the second pressure adjustment unit including a second valve chamber, a second pressure control chamber, a second communication port that allows the second valve chamber and the second pressure control chamber to communicate with each other, a second valve that opens and closes the second communication port, a second flexible member that forms a surface of a portion of the second pressure control chamber and that is configured to be displaceable, and a second pressure plate that forms a surface of another portion of the second pressure control chamber and that is configured to be displaceable by moving together with the second flexible member;
a first passage configured to allow a pressure chamber and the first pressure control chamber to communicate with each other;
a second passage configured to allow the pressure chamber and the second pressure control chamber to communicate with each other;
a third passage configured to allow the second pressure control chamber and a circulating pump to communicate with each other, the circulating pump used to circulate the liquid; and
a fourth passage configured to allow the circulating pump and the first pressure control chamber to communicate with each other, wherein
VV<V2 is satisfied
where VV is a volume of fluid passing a communication port of the first pressure control chamber and the fourth passage in a direction from the first pressure control chamber toward the fourth passage in a period from a time when operation of the circulating pump is stopped to a time when pressure in the first pressure control chamber and pressure in the second pressure control chamber become equal to each other, and V2 is a volume of the fourth passage.
